(19) United States
(12) Patent Application Publication
(10) Pub. No.: US 2008/0258345 A1
(43) Pub. Date: Oct. 23, 2008

(54) Liquid Radiation-Curing Compositions

(76) Inventors: Arthur Thomas Bens, Meerbusch (DE); Hermann Seitz, Rostock (DE); Carsten Tille, Munchen (DE)

Correspondence Address: Millen White Zelano & Branigan, 2200 Clarendon Boulevard, Suite 1400, Arlington, VA, 22201, US

(21) Appl. No.: 11/632,255

(22) PCT Filed: Jul. 15, 2005
(86) PCT No.: PCT/EP2005/053420

§ 371 Date: Mar. 7, 2008

(30) Foreign Application Priority Data
Jul. 15, 2004 (DE) 10 2004 034 416.7

(51) Int. Cl. B29C 35/04; C08L 33/02; C08J 3/28

(52) U.S. Cl. 264/401; 522/112; 522/36; 522/64; 522/65; 522/49; 522/69; 522/68; 522/81; 522/82

(57) ABSTRACT

The present invention relates to liquid radiation-curing compositions having flexible and elastic material properties in the cured state, consisting of the following components: a) from 5.0 to 99.0% by weight of a di- or polyfunctional polyether (meth)-acrylate compound having a molecular weight of more than 1000 g/mol; b) from 1.00 to 90.0% by weight of a mono-, di- or polyfunctional radiation-curing (meth)acrylate compound having a molecular weight of less than 1000 g/mol as a reactive component or reactive thinner or cross-linking agent for the formation of polymer networks; c) from 0.05 to 10.0% by weight of a free-radical forming photoinitiator; d) from 0.001 to 5.0% by weight of further components; with the proviso that the sum of components a) to d) amounts to 100% by weight. Further, the present invention relates to products obtainable from the compositions according to the invention, and processes for the preparation, treatment and use of three-dimensional shaped objects made from the compositions according to the invention.

The present invention relates to liquid radiation-curing compositions having flexible and elastic material properties in the cured state. In addition, the invention relates to products, especially three-dimensional shaped objects, including those for use in medicine and medical technology, obtainable from the compositions according to the invention. Further, the invention relates to processes for preparing a three-dimensional shaped object from the compositions according to the invention.

The use of radiation-curing acrylate compositions is widespread in the technical industry. The term “rapid prototyping” generally refers to processes for preparing three-dimensional shaped objects layer by layer using printing, milling, cutting or light-exposure processes from a wide variety of starting materials on the basis of sets of three-dimensional model data of computer-aided design (CAD) using specialized software. For a survey of the processes, see also “Rapid Prototyping”, Gebhardt, Andreas; Carl Hanser Verlag, 2003.

A very widespread process is the “stereolithography” (SLA) process. In this process, a liquid radiation-curing composition of acrylate, epoxy or other polymer resins is treated with electromagnetic radiation in the form of ultraviolet laser beams. Based on the two-dimensional layer data of a three-dimensional CAD model, the radiation-curing composition is subjected to the process of exposure to electromagnetic radiation layer by layer, so that a cured polymer profile is formed at the positions where the laser beam stroke the resin surface. In a subsequent step, the construction platform is mechanically moved vertically by a defined distance, so that, upon renewed exposure of this new liquid resin layer the next layer structure, a continuous three-dimensional shaped object is formed from the originally liquid polymer material, which is in a cured state after the course of the process (see also “Rapid Prototyping”, Gebhardt, Andreas; Carl Hanser Verlag, 2003; further, see H. Kodama's review article “Automatic method for fabricating a three-dimensional plastic model with photo-hardening polymer” in Review of Scientific Instruments, vol. 52, No. 11, November 1981, 1770-1773; and Hull's “Apparatus for Production of Three-Dimensional Objects by Stereolithography”; U.S. Pat. No. 4,575,330).

Conventional commercially available compositions for stereolithography are predominantly based on materials which are either too hard in the cured state and possess rigid and brittle material properties (typical values of Shore hardness are within a range of Shore D with 75 to 90 units according to ASTM 2240 or DIN 53505 testing protocols) or composed of insufficiently biocompatible components. As non-biocompatible main components, epoxy resin components may be mentioned, in particular. Therefore, these liquid radiation-curing compositions cannot be employed, or only conditionally so, in specialized selected fields of application in medicine or medical technology.

Commercial materials for stereolithography have only limited flexibility and are suitable only for particular fields of application. Therefore, especially if flexible and elastic shaped objects are needed as models or other construction elements, the prior art predominantly employs a three-step process. First, a correspondingly hard and brittle shaped object is prepared from commercial SLA materials. Thereafter, in an additional molding process, mainly vacuum casting or similar technologies, a negative of the shaped object is prepared as a female mold, which is subjected to casting with flexible materials (e.g., medicinally approved silicone etc.) in a final step to finally obtain a flexible and elastic shaped object.

Therefore, there is a need for compositions for stereolithography which both are composed of skin-tolerable and biocompatible components, which are mainly acrylate components as main components, and offer suitable material properties to be employed in fields of application in medicine and medical technology. Especially flexible and elastic shaped objects for combined multimodal soft/hard tissue models and for special shaped objects, e.g., instrument prototypes with a medical-technological application background could not be realized in this way to date.

There are hard and brittle SLA materials based on the acrylates group of substances which have some biocompatibility and are employed for hard tissue (especially bone materials etc.) representations, such as the SLA material SL H-C-9100 or SL Y-C-9300 sold by Huntsman (trade name “Stereocol”) and described in the following patents: U.S. Pat. No. 6,133,336, PCT/GB 94/01427 and WO 95/01257.

Flexible and elastic material properties as described in the present invention have not been known to date in the prior art. Typical ranges for the Shore hardness of the “hard polymers” previously described in the prior art are within a range of Shore D 75 to 90 units according to ASTM 2240 or DIN 53505 testing protocols. The present invention achieves soft and flexible polymers having Shore hardness values within a range of Shore A 20 to 90 units according to DIN 53505. This range of values is typical of elastomers and “soft polymers”. The difference between Shore D as a standard for hard and brittle plastic materials and Shore A for soft and flexible plastic materials may be explicitly pointed out here as an improved material property within the meaning of the invention.

A number of patents describes the application of different types of flexible or elastic polymer materials for SLA processes which are predominantly based on classes of compounds different from the polyether (meth)acrylate materials claimed here. The former classes of materials are usually insufficiently skin-tolerable, or composed of non-biocompatible original components. In particular, there may be mentioned the isocyanate monomers for polyurethanes, which are in part rated as toxic and hazardous to health. The use of these materials in medicine or medical technology is not possible, or only so to a limited extent. Examples of classes of materials employed in medicine or medical technology include polyurethane (EP 0 562 826 A1), polylactone derivatives (EP 0 477 983 A2) or polyimides (PCT/US 01/19038).

Further, the prior art describes the application of polymer materials for SLA processes and their use in medical applications, e.g., in DE 69432023 T2 and U.S. Pat. No. 5,674,921. Flexible and elastic material properties as described in the present invention and necessary, in particular, in specific medical fields of application are not achieved.

In addition, it has been successfully tried to obtain flexible SLA materials by admixing polyether polyol components with previously known epoxy-based SLA materials (WO 99/50711 or US-PA 20020177073). A critical disadvantage of these compositions is the possibility that the polyether polyol components employed as plasticizers could diffuse out of the finished shaped object. This results in a low ageing resistance and biocompatibility due to the release of plasticizing components.

Different photolithographic applications of formulations containing di- or polyfunctional polyether(meth)acrylate compounds are known in the art. The Japanese patent application JP 2003286301A describes photolithographic applications, however the described formulations consist of a mixture of a thermal initiator and a photoinitiator for producing free radicals. This combination of a thermal free-radical initiator and a photoinitiator is deemed essential for the compositions according to JP 2003286301A. A formulation consisting only of a free-radical forming photoinitiator as disclosed in the present invention is not described. Furthermore a formulation containing thermal free-radical forming initiators would be unsuited for the purposes of the present invention due to negative effects on biocompatibility, especially for the soluble parts in these mixtures.

The object of the present invention is to provide a composition which has flexible and elastic material properties in the cured state and ensures a high biocompatibility to be used, for example, for the preparation of products which can be employed in medical technology.

According to the invention, this object is achieved by a liquid radiation-curing composition having flexible and elastic material properties in the cured state, consisting of the following components:
a) from 5.0 to 99.0% by weight of a di- or polyfunctional polyether (meth)-acrylate compound having a molecular weight of more than 1000 g/mol;
b) from 1.00 to 90.0% by weight of a mono-, di- or polyfunctional radiation-curing (meth)acrylate compound having a molecular weight of less than 1000 g/mol as a reactive component or reactive thinner or cross-linking agent for the formation of polymer networks;
c) from 0.05 to 10.0% by weight of a free-radical forming photoinitiator;
d) from 0.001 to 5.0% by weight of further components;
   with the proviso that the sum of components a) to d) amounts to 100% by weight.

The particular advantages of the present invention over the prior art reside in the fact that the moieties which provide the material with the excellent flexible material properties are already components of the polymeric network structure, since the main components of the compositions according to the invention consist of polyfunctional polyether (meth)acrylates. In addition, the epoxy resin components, which are known to be toxic, are not employed in the compositions according to the invention. Further, the advantages of the compositions and processes according to the invention reside in the fact that the corresponding products can be prepared directly from the material claimed herein, circumventing the above described molding and remolding processes. This offers an enormous advantage in terms of time and cost over the method known from the prior art.

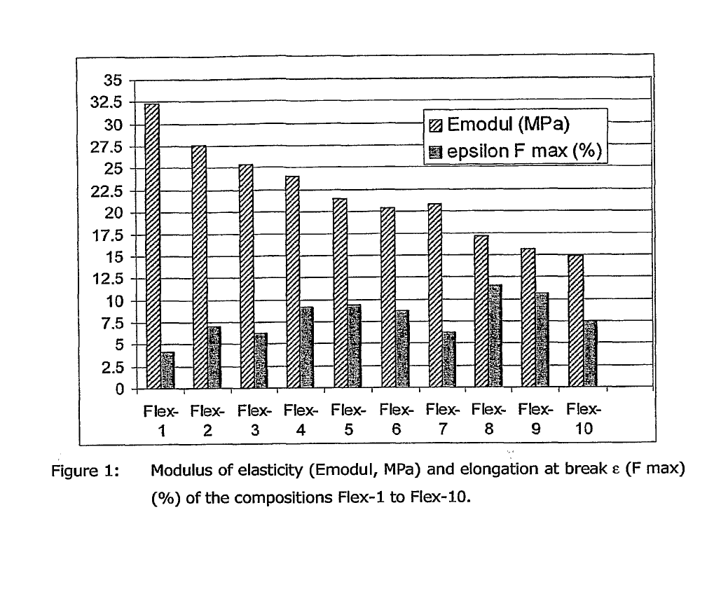

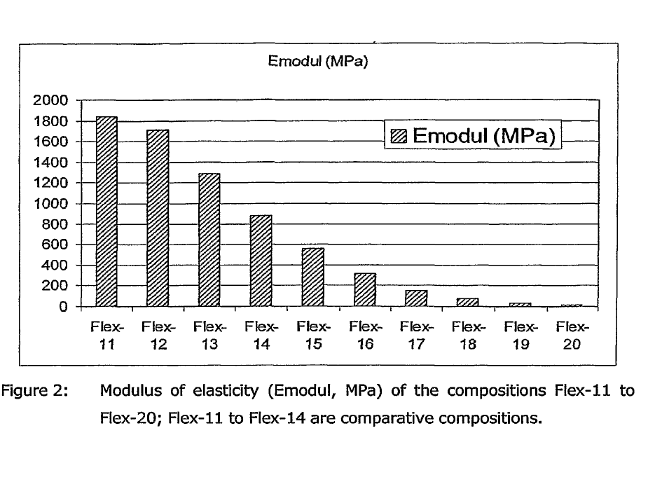

FIG. 1 and FIG. 2 show a survey of the possible range of mechanical properties of the compositions Flex-1 to Flex-20 employed.

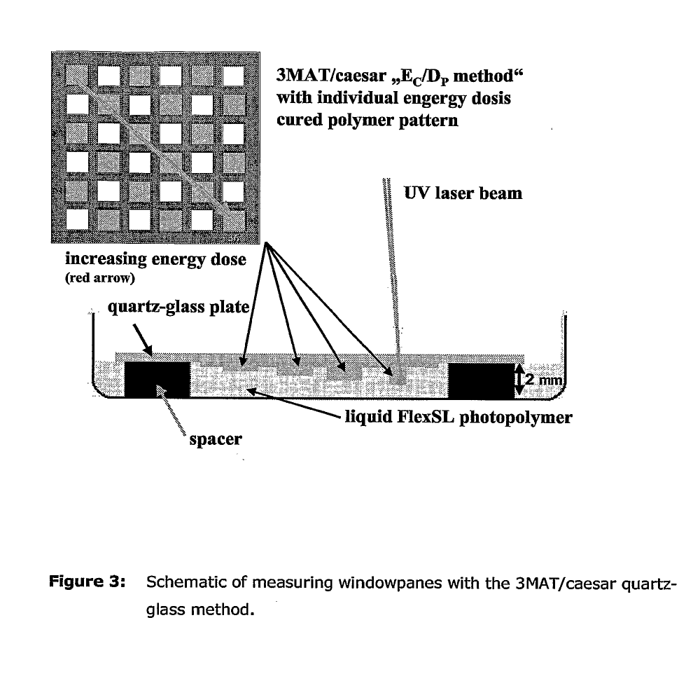

FIG. 3 shows schematically the measurement of windowpanes with the 3MAT/Caesar quartz-glass method

The composition according to the invention may additionally contain from 0.01 to 80.0% by weight of a filler material, the sum of components a) to d) plus the filler material totaling 100% by weight.

The polyether (meth)acrylate and (meth)acrylate compounds according to the invention as well as the photoinitiator also include mixtures of several di- or polyfunctional polyether (meth)acrylate compounds, several mono-, di- or poly-functional (meth)acrylate compounds as well as several photoinitiators.

“(Meth)acrylates” within the meaning of the present invention includes both acrylates and methacrylates.

Component a) may be selected from the group consisting of alkylether di(meth)-acrylates, arylether di(meth)acrylates, bis(arylether) di(meth)acrylates, alkyl-ether tri(meth)acrylates, arylether tri(meth)acrylates, bis(arylether) tri(meth)-acrylates, alkylether poly(meth)acrylates, arylether poly(meth)acrylates, bis-(arylether) poly(meth)acrylates, alkyletheralkoxy di(meth)acrylates, aryletheralkoxy di(meth)acrylates, bis(arylether)alkoxy di(meth)acrylates, alkyletheralkoxy tri(meth)acrylates, aryletheralkoxy tri(meth)acrylates, bis(aryletheralkoxy) tri(meth)acrylates, alkyletheralkoxy poly(meth)acrylates, aryletheralkoxy poly(meth)acrylates, bis(arylether) poly(meth)acrylates, polyalkylether di(meth)acrylates, polyarylether di(meth)acrylates, polyalkylether tri(meth)-acrylates, polyarylether tri(meth)acrylates, polyalkylether poly(meth)acrylates, polyarylether poly(meth)acrylates, polyalkyletheralkoxy di(meth)acrylates, polyaryletheralkoxy di(meth)acrylates, polyalkyletheralkoxy tri(meth)acrylates, polyaryletheralkoxy tri(meth)acrylates, polyalkyletheralkoxy poly(meth)acrylates, polyaryletheralkoxy poly(meth)acrylates.

In particular, component a) may be selected from the group consisting of polyalkylether di(meth)acrylates, polyethylene glycol di(meth)acrylates, polypropylene glycol di(meth)acrylates, polyisopropylene glycol di(meth)acrylates, polyisobutylene glycol di(meth)acrylates, bisphenol A alkoxylated (in particular: methoxylated, ethoxylated, propoxylated, butoxylated and higher C5-C10 alkoxylates) di(meth)acrylates, bisphenol F alkoxylate di(meth)acrylates, bisphenol B alkoxylated (in particular: methoxylated, ethoxylated, propoxylated, butoxylated and higher C5-C10 alkoxylates) di(meth)acrylates, ethoxylated bisphenol A di(meth)acrylates, ethoxylated bisphenol F di(meth)acrylates, ethoxylated bisphenol B di(meth)acrylates, propoxylated bisphenol A di(meth)acrylates, propoxylated bisphenol F di(meth)acrylates, propoxylated bisphenol B di(meth)acrylates and other alkoxylated (in particular: methoxylated, ethoxylated, propoxylated, butoxylated and higher C5-C10 alkoxylates) bisphenol derivative di(meth)acrylates.

Further compounds suitable for component a.) are stated, inter alia, in I.) Lackrohstoff-Tabellen; Erich Karsten; 10th edition; Vincentz Verlag Hannover; 2000; II.) Polymer Handbook; 4th edition; Editors: J. Brandrup, E. H. Immergut & E. A. Grulke; Wiley Verlag; 1999; and III.) Chemistry & Technology of UV&EB Formulation for Coatings, Inks & Paints: Volume III—Prepolymers & Reactive Diluents; Editor: G. Webster; SITA Technology Ltd. London; published by John Wiley & Sons Ltd., London, 1997. The contents of these documents are included herein by reference.

It may be preferred that component a) represents from 5 to 80% by weight or from 10 to 80% by weight.

Component b) may be selected from the group consisting of alkylether di(meth)acrylates, arylether di(meth)acrylates, bis(arylether) di(meth)acrylates, alkylether tri(meth)acrylates, arylether tri(meth)acrylates, bis(arylether) tri-(meth)acrylates, alkylether poly(meth)acrylates, arylether poly(meth)acrylates, bis(arylether) poly(meth)acrylates, alkyletheralkoxy di(meth)acrylates, aryletheralkoxy di(meth)acrylates, bis(aryletheralkoxy) di(meth)acrylates, alkyletheralkoxy tri(meth)acrylates, a ryletheral koxy tri(meth)acrylates, bis(aryletheralkoxy) tri(meth)acrylates, alkyletheralkoxy poly(meth)acrylates, aryletheralkoxy poly(meth)acrylates, bis(arylether) poly(meth)acrylates, polyalkylether di(meth)acrylates, polyarylether di(meth)acrylates, polyalkylether tri(meth)-acrylates, polyarylether tri(meth)acrylates, polyalkylether poly(meth)acrylates, polyarylether poly(meth)acrylates, polya Ikylethera Ikoxy di(meth)acrylates, polyaryletheralkoxy di(meth)acrylates, polyalkyletheral koxy tri(meth)acrylates, polyaryletheralkoxy tri(meth)acrylates, polyalkylethera Ikoxy poly(meth)acrylates, polyaryletheralkoxy poly(meth)acrylates, n-alkyl (in particular: methyl, ethyl, propyl, butyl and higher C5-C10 alkyls)(meth)acrylates or branched-chain alkyl (meth)acrylates with alkyl carbon chain lengths of from 1 to 18 carbon atoms, hydroxyalkyl (meth)acrylates, phenoxyalkyl (meth)acrylates, isobornyl (meth)acrylate, tetrahydrofurfuryl (meth)acrylate, cyclohexyl (meth)acrylate, dicyclopentenyl (meth)acrylate, dicyclopentenyloxyalkyl (meth)acrylates, methoxyether (meth)acrylates, ethoxyether (meth)acrylates, aliphatic urethane(meth)acrylates, aromatic urethane (meth)acrylates, aliphatic polyether urethane (meth)acrylates, aromatic polyether urethane (meth)acrylates, aliphatic polyester urethane (meth)acrylates, aromatic polyester urethane (meth)acrylates, alkenyl glycol di(meth)acrylates, aliphatic di(meth)acrylates, allyl (meth)acrylates, trimethylolpropane tri(meth)acrylate, pentaerythritol tri(meth)acrylate, ethoxylated trimethylolpropane tri(meth)acrylate, ethoxylated pentaerythritol tri(meth)acrylate, propoxylated trimethylolpropane tri(meth)acrylate, propoxylated pentaerythritol tri(meth)acrylate, ethoxylated glyceryl tri(meth)acrylate, propoxylated glyceryl tri(meth)acrylate, tris(2-hydroxyalkyl) isocyanurate tri(meth)acrylates, allylether (meth)acrylates, trivinylether (meth)acrylates, pentaerythritol tetra(meth)acrylate, ditrimethylolpropane tetra(meth)acrylate, alkoxylated (in particular: methoxylated, ethoxylated, propoxylated, butoxylated and higher C5-C10 alkoxylates) tri(meth)acrylates, alkoxylated (in particular: methoxylated, ethoxylated, propoxylated, butoxylated and higher C5-C10 alkoxylates) tetra(meth)acrylates, alkoxylated (in particular: methoxylated, ethoxylated, propoxylated, butoxylated and higher C5-C10 alkoxylates) penta(meth)acrylates, alkoxylated (in particular: methoxylated, ethoxylated, propoxylated, butoxylated and higher C5-C10 alkoxylates) hexa(meth)acrylates, dipentaerythritol penta(meth)acrylate, dipentaerythritol hexa(meth)acrylate.

In particular, component b) may be selected from the group consisting of: polyalkylether di(meth)acrylates, polyethylene glycol di(meth)acrylates, polypropylene glycol di(meth)acrylates, polyisopropylene glycol di(meth)acrylates, polyisobutylene glycol di(meth)acrylates, bisphenol A alkoxylated (in particular: methoxylated, ethoxylated, propoxylated, butoxylated and higher C5-C10 alkoxylates) di(meth)acrylates, bisphenol F alkoxylated (in particular: methoxylated, ethoxylated, propoxylated, butoxylated and higher C5-C10 alkoxylates) di(meth)acrylates, bisphenol B alkoxylated (in particular: methoxylated, ethoxylated, propoxylated, butoxylated and higher C5-C10 alkoxylates) di(meth)acrylates, ethoxylated bisphenol A di(meth)acrylates, ethoxylated bisphenol F di(meth)acrylates, ethoxylated bisphenol B di(meth)acrylates, propoxylated bisphenol A di(meth)acrylates, propoxylated bisphenol F di(meth)acrylates, propoxylated bisphenol B di(meth)acrylates, alkoxylated (in particular: methoxylated, ethoxylated, propoxylated, butoxylated and higher C5-C10 alkoxylates) bisphenol derivative di(meth)acrylates, n-alkyl (in particular: methyl, ethyl, propyl, butyl and higher C5-C10 alkyls)(meth)acrylates or branched-chain alkyl (meth)acrylates with alkyl carbon chain lengths of from 1 to 12 carbon atoms, hydroxyalkyl (meth)acrylates with alkyl carbon chain lengths of from 1 to 12 carbon atoms, phenoxyalkyl (meth)acrylates, isobornyl (meth)acrylate, tetrahydrofurfuryl (meth)acrylate, cyclohexyl (meth)acrylate, dicyclopentenyl (meth)acrylate, dicyclopentenyloxyalkyl (meth)acrylates, methoxyether (meth)acrylates, ethoxyether (meth)acrylates, alkenyl glycol di(meth)acrylates, aliphatic di(meth)acrylates, al lyl (meth)acrylates, trimethylolpropane tri(meth)acrylate, pentaerythritol tri(meth)acrylate, ethoxylated trimethylolpropane tri(meth)acrylate, ethoxylated pentaerythritol tri(meth)acrylate, propoxylated tri methylol propane tri(meth)acrylate, propoxylated pentaerythritol tri(meth)acrylate, ethoxylated glyceryl tri(meth)acrylate, propoxylated glyceryl tri(meth)acrylate, pentaerythritol tetra(meth)acrylate, ditrimethylolpropane tetra(meth)acrylate, alkoxylated (in particular: methoxylated, ethoxylated, propoxylated, butoxylated and higher C5-C10 alkoxylates) tri(meth)acrylates, alkoxylated (in particular: methoxylated, ethoxylated, propoxylated, butoxylated and higher C5-C10 alkoxylates) tetra(meth)acrylates, alkoxylated (in particular: methoxylated, ethoxylated, propoxylated, butoxylated and higher C5-C10 alkoxylates) penta(meth)acrylates, alkoxylated (in particular: methoxylated, ethoxylated, propoxylated, butoxylated and higher C5-C10 alkoxylates) hexa(meth)acrylates, dipentaerythritol penta(meth)acrylate, dipentaerythritol hexa(meth)acrylate.

It may be preferred that component b) represents from 1 to 50% by weight or from 1 to 60% by weight.

Further suitable reactive monomers and reactive di- or tri-, tetra-, penta-, hexa- or polyfunctional oligomers, especially mono-, di- or polyfunctional (meth)acrylate compounds are stated, inter alia, in I.) Lackrohstoff-Tabellen; Erich Karsten; 10th edition; Vincentz Verlag Hannover; 2000; II.) Polymer Handbook; 4th edition; Editors: J. Brandrup, E. H. Immergut & E. A. Grulke; Wiley Verlag; 1999; and III.) Chemistry & Technology of UV&EB Formulation for Coatings, Inks & Paints: Volume III—Prepolymers & Reactive Diluents; Editor: G. Webster; SITA Technology Ltd. London; published by John Wiley &. Sons Ltd., London, 1997. The contents of these documents are included herein by reference. Commercially available compounds can be obtained, inter alia, from the company Atofina and its subsidiary companies Sartomer and Cray Valley, and can be also received commercially from the company Rahn AG. Examples thereof are stated with their trade names in the following (name of the (meth)acrylate compound ((short form) trade name)): 2-(2-ethoxyethoxy)ethyl acrylate ((EOEOEA) SR256), 2-phenoxyethyl acrylate ((PEA) SR339C), caprolactone acrylate (SR495), cyclic trimethylolpropane formal acrylate ((CTFA) SR531), ethoxylated 4-nonyl phenol acrylate (SR504), isobornyl acrylate ((IBOA) SR506D), isodecyl acrylate ((IDA) SR395), lauryl acrylate (SR335), octyl decyl acrylate ((ODA) SR484), stearyl acrylate (SR257C), tetrahydrofurfuryl acrylate ((THFA) SR285), tridecyl acrylate (SR489), 1,6-hexanediol diacrylate ((HDDA) SR238), alkoxylated diacrylate (SR802), alkoxylated hexanediol diacrylate (CD561), diethylene glycol diacrylate ((DEGDA) SR230), dipropylene glycol diacrylate ((DPGDA) SR508), esterdiol diacrylate (SR606A), ethoxylated₁₀ bisphenol A diacrylate (SR602), ethoxylated₃ bisphenol A diacrylate (SR349), ethoxylated₄ bisphenol A diacrylate (SR601E), polyethylene glycol 200 diacrylate ((PEG200DA) SR259), polyethylene glycol 400 diacrylate ((PEG400DA) SR344), polyethylene glycol 600 diacrylate ((PEG600DA) SR610), propoxylated₂ neopen-tyl glycol diacrylate ((PONPGDA) SR9003), tetraethylene glycol diacrylate ((TTEGDA) SR268US), tricyclodecanedimethanol diacrylate ((TCDDMDA) SR833S), triethylene glycol diacrylate ((TIEGDA) SR272), tripropylene glycol diacrylate ((TPGDA) SR306), dipentaerythritol pentaacrylate ((DiPEPA) SR399), ditrimethylolpropane tetraacrylate ((Di TMPTTA) SR355), ethoxylated₁₅ trimethylolpropane triacrylate (CN435), ethoxylated₂₀ trimethylolpropane triacrylate (SR415), ethoxylated₃ trimethylolpropane triacrylate ((TMPEOTA) SR454), ethoxylated₄ pentaerythritol tetraacrylate ((PPTTA) SR494), ethoxylated₅ pentaerythritol tetraacrylate ((PPTTA) SR594), ethoxylated₅ pentaerythritol triacrylate (SR593), ethoxylatedg trimethylolpropane triacrylate (SR502), highly propoxylated glycerol triacrylate (SR9021), modified pentaerythritol triacrylate (SR444), pentaerythritol tetraacrylate ((PETTA) SR295), pentaerythritol triacrylate (SR444D), propoxylated glycerol triacrylate ((GPTA) SR9019), propoxylated glycerol triacrylate ((GPTA) SR9020), propoxylated3 trimethylolpropane triacrylate ((TMPPOTA) SR492), trimethylolpropane triacrylate ((TMPTA) SR351), tris(2-hydroxyethyl)isocyanurates triacrylate ((THEICTA) SR368), 2-phenoxyethyl methacrylate (SR340), ethoxylated₁₀ hydroxyethyl methacrylate (CD572), isobornyl methacrylate (SR423A), lauryl methacrylate (SR313E), methoxy polyethylene glycol 350 monomethacrylate (CD550), methoxy polyethylene glycol 550 monomethacrylate (CD552), polypropylene glycol monomethacrylate (SR604), stearyl methacrylate (SR324D), tetrahydrofurfuryl methacrylate ((THFMA) SR203), 1,3-butylene glycol dimethacrylate ((BGDMA) SR2973), 1,4-butanediol dimethacrylate ((BDDMA) SR214), 1,6-hexanediol dimethacrylate ((HDDMA) SR239A), diethylene glycol dimethacrylate ((DEGDMA) SR231), ethoxylated₁₀ bisphenol A dimethacrylate (SR480), ethoxylated₂ bisphenol A dimethacrylate (SR348L), ethoxylated₂ bisphenol A dimethacrylate (SR101), ethoxylated₃ bisphenol A dimethacrylate (SR348C), ethoxylated₄ bisphenol A dimethacrylate (CD540), ethoxylated₄ bisphenol A dimethacrylate (SR150), ethylene glycol dimethacrylate (EGDMA) (SR206), polyethylene glycol 200 dimethacrylate ((PEG20ODMA) SR210), polyethylene glycol 400 dimethacrylate ((PEG40ODMA) SR6030P), polyethylene glycol 600 dimethacrylate ((PEG60ODMA) SR252), tetraethylene glycol dimethacrylate ((TTEGDMA) SR209), triethylene glycol dimethacrylate ((TIEGDMA) SR205), trimethylolpropane trimethacrylate ((TMPTMA) SR350), polybutadiene, dimethacrylate (CN301), difunctional polyester acrylates (CN UVP210), hexafunctional polyester acrylates (CN293), polyester acrylates (CN203), polyester acrylates (SYNOCURE AC1007), tetrafunctional polyester acrylates (CN294E), tetrafunctional polyester acrylates (CN UVP220), MIRAMER M100 (Caprolactone Acrylate), MIRAMER M144 (4-Phenoxyethyl acrylate), MIRAMER M164 (Ethoxylated(4) Nonylphenol acrylate), MIRAMER M1602 (Nonylphenol propoxylated(2) acrylate), MIRAMER M200 (Hexanediol diacrylate), MIRAMER M202 (1,6-Hexanediol ethoxylated(3) diacrylate), MIRAMER M210 (Hydroxypivalic acid neopentylglycol diacrylate), MIRAMER M220 (Tripropylene glycol diacrylate), MIRAMER M222 (Dipropylene glycol diacrylate), MIRAMER M280 (Polyethylene glycol 400 diacrylate), MIRAMER M281 (Polyethylene glycol 400 dimethacrylate), MIRAMER M284 (Polyethylene glycol 300 diacrylate), MIRAMER M2101 (Ethoxylated(10) Bisphenol A dimethacrylate), MIRAMER M2301 (Ethoxylated(30) Bisphenol A dimethacrylate), MIRAMER M216 (Neopentyl glycol propoxylated(2) diacrylate), MIRAMER M270 (Tetraethylene glycol diacrylate), MIRAMER M282 (Polyethylene glycol(200) diacrylate), MIRAMER M286 (Polyethylene glycol(600) diacrylate), MIRAMER M300 (Trimethylolpropane triacrylate), MIRAMER M320 (Glycerolpropoxy triacrylate), MIRAMER M340 (Pentaerythritol triacrylate), MIRAMER M3130 (Triacrylate of oxyethylated Trimethylolpropane), MIRAMER M3160 (Trimethylolpropane ethoxylated(6) triacrylate), MIRAMER M410 (Ditrimethylolpropane tetraacrylate), MIRAMER M4004 (Ethoxylated Pentaerythritol Tetraacyrlate), MIRAMER M600 (Dipentaerythritol hexaacrylate), MIRAMER M360 (Trimethylolpropane propoxylated(3) triacrylate), MIRAMER M3190 (Trimethylolpropane ethoxylated(9) triacrylate) MIRAMER M420 (Pentaerythritol tetraacrylate), GENOMER 4215 (Aliphatic Polyester Urethane Acrylate), GENOMER 4269/M22 (Aliphatic Urethane Acrylate in GENOMER* 1122 (Monofunctional Urethane Acrylate), GENOMER 4312 (Aliphatic Polyester Urethane Acrylate.), GENOMER 4316 (Aliphatic Polyester Urethane Acrylate), GENOMER 4590/PP (Urethane Acrylate in GENOMER 1456), URETHANE ACRYLATE 98-283/W, URETHANE ACRYLATE 00-022, URETHANE ACRYLATE 04-122, Genomer 4205 (aliphatic urethane acrylate), Genomer 4256 (aliphatic polyester urethane methacrylate), Genomer 4297, GENOMER 3364 (Modified Polyetherpolyol Acrylate), GENOMER 3497 (Modified Polyetherpolyol Acrylate), POLYETHER ACRYLATE 01-514, POLYESTER ACRYLATE 03-849, MIRAMER M166 (Ethoxylated(8) Nonylphenol acrylate), MIRAMER M180 (Stearyl acrylate), MIRAMER M100 (Caprolactone acrylate), MIRAMER M144 (4-Phenoxyethyl acrylate), MIRAMER M164 (Ethoxylated(4) Nonylphenol acrylate), MIRAMER M1602 (Nonylphenol propoxylated(2) acrylate), MIRAMER M202 (1,6-Hexanediol ethoxylated(3) diacrylate), MIRAMER M210 (Hydroxypivalic acid neopentylglycol diacrylate), MIRAMER M281 (Polyethylene glycol 400 dimethacrylate), MIRAMER M284 (Polyethylene glycol 300 diacrylate), MIRAMER M286 (Polyethylene glycol(600) diacrylate), MIRAMER M2301 (Bisphenol A ethoxylated (30) dimethacrylate), MIRAMER M216 (Neopentyl glycol propoxylated(2) diacrylate), MIRAMER M270 (Tetraethylene glycol diacrylate), MIRAMER M282 (Polyethylene glycol(200) diacrylate), MIRAMER M286 (Polyethylene glycol(600) diacrylate), MIRAMER M340 (Pentaerythritol triacrylate), MIRAMER M3160 (Trimethylolpropane ethoxylated(6) triacrylate), MIRAMER M360 (Trimethylolpropane propoxylated(3) triacrylate), MIRAMER M3190 (Trimethylolpropane ethoxylated(9) triacrylate), MIRAMER M420 (Pentaerythritol tetraacrylate), etc.

Component c) may be selected from the group consisting of benzoin ether and derivatives, benzil ketals, α,α-dialkyloxyacetophenone derivatives; hydroxyalkylphenones, α-aminoalkylphenones, acylphosphine oxides, phenylglyoxalates, benzophenone derivatives, thioxanthone derivatives, 1,2-diketones, aromatic ketones and amine-based co-photoinitiators. Mixtures (blends) of several photoinitiators are also possible.

In addition, component c) may be incorporated into the polymer network during the reaction through a (meth)acrylate-based esterification, so that component c.) may be selected from the group consisting of: (meth)acrylate-esterified benzoin ethers, benzil ketals, (meth)acrylate-esterified α,α-dialkyloxyacetophenone derivatives; (meth)acrylate-esterified hydroxyalkylphenones, (meth)-acrylate-esterified α-aminoalkylphenones, (meth)acrylate-esterified acylphosphine oxide, phenylglyoxalates, (meth)acrylate-esterified benzophenone derivatives, (meth)acrylate-esterified thioxanthone derivatives, (meth)acrylate-esterifled 1,2-diketones, (meth)acrylate-esterified aromatic ketones. Further suitable photoinitiators are stated in I. Lackrohstoff-Tabellen; Erich Karsten; 10th edition; Vincentz Verlag Hannover; 2000, and also in II. Photoinitiators for Free Radical, Cationic & Anionic Photopolymerisation; J. V. Crivello, K. Dietliker; SITA Technology Ltd. London; published by John Wiley & Sons Ltd., London, 1998. The contents of these documents are included herein by reference. In particular, the following concrete commercially available photoinitiator classes from II. may be mentioned: benzoin derivatives, methylolbenzoin derivatives, 4-benzoyl-1,3-dioxolane derivatives, benzil ketal derivatives, α,α-dialkyloxyacetophenone derivatives, α-hydroxyalkylphenone derivatives, α-hydroxyalkylphenone derivatives with polysiloxane substituents, 1-hydroxycyclohexyl phenyl ketone/benzophenone mixtures, α-aminoalkylphenone derivatives, acylphosphine oxide derivatives, acylphosphine oxide sulfides and acylphosphines, O-acyl-α-oxlmino-ketone derivatives, halogenated acetophenone derivatives, phenylglyoxylate derivatives, aromatic ketone/co-initiator mixtures (e.g., benzophenone derivatives/amines; Michler's ketone/benzophenone; thioxanthone derivatives/amines, etc.), polymer-bound photoinitiators, transition metal complex compounds in combination with polyhalogen derivatives, titanocene photoinitiators, organic dye/co-initiator systems (e.g., dye/borate salt co-initiator systems, dye/organo-metallic derivative systems, dye/bisimidazole systems, ketocoumarin/co-initiator systems, etc.). Commerically available Photoinitiators can be purchased from Ciba Specialties Inc. (Tradename Irgacure™ or Darocure™, in particular Irgacure™ 184 (1-Hydroxy-cyclohexylphenyl-ketone), Irgacure™ 369 (Aminoke-tone 2-Benzyl-2-(dimethylamino)-1-[4-(4-morpholinyl) phenyl]-1-butanone) and Irgacure™ 907 (2-Methyl-1-[4-(methylthio) phenyl] -2-(4-morpholinyl)-1-propanone) and other photoinitiators of the Irgacure™ Darocure™ series, for example: IRGACURE™ 500 (IRGACURE(™) 184 (50 wt %), benzophenone (50 wt %)), DAROCUR™ 1173 (hydroxyketone 2-Hydroxy-2-methyl-1-phenyl-1-propanon), IRGACURE™ 2959 (hydroxyketone 2-Hydroxy-1-[4-(2-hydroxyethoxy) phenyl]-2-methyl-1-propanone), DAROCUR MBF (phenylglyoxylate Methylbenzoylformate), IRGACURE™ 754 (phenylglyoxylate oxy-phenyl-acetic acid 2-[2 oxo-2-phenyl-acetoxy-ethoxy]-ethyl ester and oxy-phenyl-acetic 2-[2-hydroxy-ethoxy]-ethyl ester), IRGACURE™ 651 (benzyldimethyl-ketal alpha-phenylacetophenone), IRGACURE™ 1300 (IRGACURE™ 369 (30 wt %) +IRGACURE™ 651 (70 wt %)), DAROCUR™ TPO (mono Acyl Diphenyl (2,4,6-trimethylbenzoyl)-phosphine (MAPO) and phosphineoxide), IRGACURE™ 819 (phosphine oxide and phenyl bis(2,4,6-trimethyl benzoyl), IRGACURE™ 2022 (DAROCUR™ 1173 (80 wt %) +IRGACURE™ 819 (20 wt %)), IRGACURE™ 2100 (Phosphine oxide), IRGACURE™ 784 ((Bis(eta 5-2,4-cyclopentadien-1-yl)Bis [2,6-difluoro-3-(1H-pyrrol-1-yl) phenyl]titanium), IRGACURE™ 250 ((4-methylphenyl) [4-(2-methyl propyl) phenyl] - hexafluorophosphate(1-) Iodonium salt)) and many other companies, e.g. Rahn AG (Tradename Genocureυ) Examples for photoinitiators, available from Rahn AG include: GENOCURE BDK (Benzildimethylketal), GENOCURE BP (Diphenylmethanone), GENOCURE CPK (1-Hydroxy-cyclohexyl-phenyl-ketone), GENOCURE DMHA (2-Hydroxy-2-methyl-1-phenyl-1-propa none), GENOCURE EHA (2-Ethyl hexyl-p-dimethylaminobenzoate), GENOCURE EPD (Aminobenzoate), GENOCURE ITX (Thioxanthone), GENOCURE LTM (Liquid Photoinitiatorblend), GENOCURE MBF(Methylbenzoylformate), GENOCURE MDEA (2,2′-(methylimino)diethanol), GENOCURE PBZ (4-Phenylbenzophenone), GENOCURE PMP (2-methyl-1-(4-methylthio)phenyl-2-morpholino-propan-1-one), GENOCURE TPO (Phosphine oxid), GENOCURE LBC(1:1 mixture of 1-Hydroxy-cyclohexyl-phenyl-ketone and Benzophenone), GENOCURE LBP (Aromatic Ketone), GENOCURE MBB (o-Methylbenzoylbenzoate))

It may be preferred that component c) represents from 0.1 to 2.5% by weight, from 0.1 to 3% by weight or from 0.1 to 4% by weight.

In addition, it may be preferred that the composition according to the invention contains from 1.0 to 80.0% by weight of a filler material. Suitable filler materials within the meaning of the present invention include, e.g., organic polymers, such as suitable biocompatible polymethacrylates, polyacrylates, polyesters, polyamides, polyimines, polyethers, polyurethanes, polyaryls, polystyrenes, polyvinylpyrrolidones, polylactides, polysaccharides, polysiloxanes, polysilicones, (meth)acrylate-silicone and silicone-(meth)acrylate core-shell copolymers in form of beads or powder or other types of structured polymer blends (e.g. nanosized Genioperl materials, a Trademark of Wacker Silicones) and further technical and other polymers and copolymers as stated in the Polymer Handbook; 4th Edition; Editors: J. Brandrup, E. H. Immergut & E. A. Grulke; Wiley Verlag; 1999, which is included herein by reference. Inorganic filler materials may be selected, for example, from the group consisting of hydroxyapatite, tricalcium phosphate and other calcium minerals, such as calcium sulfates and calcium phosphates, calcium phosphites, calcium carbonates and calcium oxalates, titanium dioxide, silica in the form of glass beads or glass fibers or finely ground glass dust.

It may be preferred that the filler material represents from 1 to 50% by weight. Component d) may be selected from the group consisting of antioxidants, polymerization inhibitors, stabilizers, processing aids, dyes, in particular photo-chromic dyes, thermochromic dyes and reactive dyes, photosensitive acids, photosensitive bases, pigments, emulsifiers, dispersing agents, wetting agents, adhesion promoters, flow-control agents, solvents, viscosity modifiers, defoamers, flame-retardant agents, ultraviolet active stabilizers, film-forming agents. Further suitable fillers are stated in the document Lackrohstoff-Tabellen; Erich Karsten; 10th edition; Vincentz Verlag Hannover; 2000, which is included herein by reference. Concrete examples thereof are selected from antisettling agents, adsorbents, non-stick agents, corrosion inhibitors, defoamers and deaerating agents, antistatic agents, optical brighteners, floating (flooding) agents, anti-flotation (anti-flooding) agents, copolymerization agents, anti-thickening agents, gloss-enhancing agents, lubricants, adhesion promoters, antiskinning agents, catalysts, preservatives, light stabilizers, matting agents, wetting and dispersing additives, grindability improvers, stabilizers, thermal protectors, rheological additives, propellants for aerosols, release agents, esterification agents, flow-control additives, flame-retardant additives, hydrophobizing agents, anti-odor agents, neutralizers, waxes, emulsifiers, desiccants, ultraviolet active stabilizers, lightstabilizers and anti-ageing components.

It may be preferred that component d) represents from 0.1 to 3% by weight or from 0.1 to 4% by weight.

By irradiating the compositions according to the invention with actinic radiation, a product can be obtained which also falls into the scope of the present invention. Preferably, the product according to the invention is a three-dimensional shaped object. The product according to the invention has characteristic material properties which can be determined by measuring the modulus of elasticity (Young 's modulus) and the elongation at break ε (Fmax) (change in length when the specimen breaks in tensile testing). It is preferred that the product according to the invention has a modulus of elasticity (Young s modulus)of at most 650 MPa and an elongation at break ε (Fmax) of at least 2.0%.

The present invention further includes a process for the preparation of the three-dimensional shaped objects according to the invention. In this process, a two-dimensional layered body is cured or solidified at the boundary layer of the composition according to the invention. Thereafter, another uncured two-dimensional layer is produced by a parallel translation by a defined distance from the previous layer. The new layer is subsequently cured or solidified to form a three-dimensional cohesive body. Repeating the steps described yields a three-dimensional shaped object.

The process according to the invention preferably employs lithographic, especially stereolithographic, methods as well as computer-controlled process techniques for data processing, data preparation and process control. The three-dimensional shaped objects can be produced layer by layer by mask or point or area exposure to actinic radiation from a range of from 200 to 600 nm, preferably from a range of from 250 to 450 nm. To produce the actinic radiation, lasers may be used, especially ultraviolet lasers, such as dye lasers, gas lasers, especially helium-cadmium lasers, as well as solid-state lasers, especially frequency-multiplied neodymium-solid state lasers.

After their preparation, the three-dimensional shaped objects according to the invention may be subjected to further processes, for example, in order to influence the material properties or appearance. These include, for example, processes in which the three-dimensional shaped objects are stored in a solvent, such as acetone, methanol, ethanol, propanol, isopropanol and further alcohols, especially primary, secondary or tertiary carbon alkane alcohols having carbon chain lengths of from 4 to 12 carbon atoms, in addition to alkane (poly)ether compounds and alkaneglycol alkyl ethers (for example, the ethers of the DowanolTm product series of the Dow Chemical Company, such as TPM (tripropylene glycol methyl ether), TPnB (tripropylene glycol n-butyl ether), DPnP (dipropylene glycol n-propyl ether)) at temperatures of from 20 to 100 ° C. for periods of from 5 minutes to 72 hours. The three-dimensional shaped objects according to the invention may also be subjected to ultrasonication or after-exposed (flood exposed) by exposure to actinic radiation, wherein actinic radiation within a range of from 250 to 600 nm, preferably within a range of from 250 to 400 nm is employed for a period of from 1 minute to 12 hours, preferably for a period of from 5 minutes to 60 minutes. In addition, the three-dimensional shaped objects according to the invention may be subjected to a heat treatment in a temperature range of from 20 to 200° C. or obtain a polymer, metal or ceramic coating, preferably a paint-coating with polymer lacquers.

The stated processes change the material properties of the three-dimensional shaped objects as compared to untreated shaped objects. It is preferred that the shaped objects treated according to the invention have a modulus of elasticity (Young's modulus)of at most 750 MPa and an ε (Fmax) of at least 2.0%.

The three-dimensional shaped objects according to the invention may be employed in applications in medicine and medical technology, especially as models for anatomic hard and soft tissue representations, for the preparation and planning of surgery, as drilling templates or positioning aids or for aiding in instrument navigation in surgical interventions, as eye, nose, face and ear epitheses, obturator prosthesis, ear epithesis and hearing aid as well as an otoplastic, as a lining, coating or exterior wall of medical instruments individually adapted to the patient, and as a long-term or short-term implant in the body of a mammal, especially a human.

The invention will be further illustrated by the following Examples.

### General Preparation Examples for the Compositions Flex-1 to Flex-26:

The individual components were acquired from or supplied as samples by the following companies: Sigma Aldrich Inc., Merck AG; Ciba Spezialitatenchemie GmbH (Irgacure™).

Components A to E were successively weighed on an analytical scale and admixed with the corresponding photoinitiator PI and additive F in a glass vessel. This mixture is then vigorously stirred at room temperature for about 24-72 hours with protection from light by means of a magnetic stirrer until all components are homogeneously mixed or dissolved.

### Determination of the Material Characteristics of the Compositions Flex-1 to Flex-26:

The mechanical material characteristics were determined on specimens cured with UV-A light (Lumatec high-performance ultraviolet lamp, type SUV-DC-P) (respective individual UV-A radiation dose of the dumbbell specimens: about 1.8 J/cm²). The mechanical characteristics modulus of elasticity, tensile strength at break (σbreak=tension in MPa occurring when the specimens break) and elongation at break (ε (Fmax) =elongation in % when the specimens break) were determined by means of mechanical tensile testing specimens (dumbbell specimens; in accordance with type S3a) in accordance with a DIN tensile testing protocol (DIN 53504) by means of a universal testing machine (Zwick). In addition, a comparative characteristic σ (0.5%) is determined, which represents the tension to be applied for changing the length of the test specimens by an amount of 0.5%.

Material characteristics for the photochemical reactivity of the compositions which are interesting in terms of process technology were established for the Flex-21 to Flex-23 (see Table 4) in an experimental stereolithographic machine “MSTL 2001” (research center caesar: HeCd laser system from Melles Griot (Carlsbad, Calif., USA), laser model: 3214N with a. wavelength of 325 nm) and for the Flex-1 to Flex-128 on a commercial stereolithographic machine “Viper” (SLA-system type: Viper Si²™ from 3D Systems Inc., Valencia, USA) operating with a solid state laser system at the wavelength 355 nm) by means of our own, especially developed exposure geometries (Ec and Dp exposure parameters calculated by analogy with P. F. Jacobs; Fundamentals of Stereolithography, 3D Systems Inc., 1992; for a detailed description of the used method and protocol see also page 27 et seq. “Testing of process parameters Dₚ and E_{c}” and FIG. 3.).

The commercial Comparative Examples 1 to 6 and the rigid and brittle compositions C-1 to C-4 (corresponding to Flex-11 to Flex-14, respectively) in Table 3 are comparative compositions.

TABLE 1
Composition Examples (respectively stated in % by weight*)

| | (Main) component | | | | | | |
|---|---|---|---|---|---|---|---|
| | A (polyether | | | | | | |
| | (meth)acrylate) | Component B | Component C | Component D | Component E | Additive F | Photoinitiator PI |
| Flex-1 | 10% bisphenol A | 90% bisphenol | — | — | — | — | 1.0% Irgacure ™ |
| | ethoxylate | A ethoxylate | | | | | 184 |
| | (15EO/phenol) | (4EO/phenol) | | | | | |
| | dimethacrylate | diacrylate | | | | | |
| | (MW ~1700) | | | | | | |
| Flex-2 | 20% bisphenol A | 80% bisphenol | — | — | — | — | 1.0% Irgacure ™ |
| | ethoxylate | A ethoxylate | | | | | 184 |
| | (15EO/phenol) | (4EO/phenol) | | | | | |
| | dimethacrylate | diacrylate | | | | | |
| | (MW ~1700) | | | | | | |
| Flex-3 | 30% bisphenol A | 70% bisphenol | — | — | — | — | 1.0% Irgacure ™ |
| | ethoxylate | A ethoxylate | | | | | 184 |
| | (15EO/phenol) | (4EO/phenol) | | | | | |
| | dimethacrylate | diacrylate | | | | | |
| | (MW ~1700) | | | | | | |
| Flex-4 | 40% bisphenol A | 60% bisphenol | — | — | — | — | 1.0% Irgacure ™ |
| | ethoxylate | A ethoxylate | | | | | 184 |
| | (15EO/phenol) | (4EO/phenol) | | | | | |
| | dimethacrylate | diacrylate | | | | | |
| | (MW ~1700) | | | | | | |
| Flex-5 | 50% bisphenol A | 50% bisphenol | — | — | — | — | 1.0% Irgacure ™ |
| | ethoxylate | A ethoxylate | | | | | 184 |
| | (15EO/phenol) | (4EO/phenol) | | | | | |
| | dimethacrylate | diacrylate | | | | | |
| | (MW ~1700) | | | | | | |
| Flex-6 | 60% bisphenol A | 40% bisphenol | — | — | — | — | 1.0% Irgacure ™ |
| | ethoxylate | A ethoxylate | | | | | 184 |
| | (15EO/phenol) | (4EO/phenol) | | | | | |
| | dimethacrylate | diacrylate | | | | | |
| | (MW ~1700) | | | | | | |
| Flex-7 | 70% bisphenol A | 30% bisphenol | — | — | — | — | 1.0% Irgacure ™ |
| | ethoxylate | A ethoxylate | | | | | 184 |
| | (15EO/phenol) | (4EO/phenol) | | | | | |
| | dimethacrylate | diacrylate | | | | | |
| | (MW ~1700) | | | | | | |
| Flex-8 | 80% bisphenol A | 20% bisphenol | — | — | — | — | 1.0% Irgacure ™ |
| | ethoxylate | A ethoxylate | | | | | 184 |
| | (15EO/phenol) | (4EO/phenol) | | | | | |
| | dimethacrylate | diacrylate | | | | | |
| | (MW ~1700) | | | | | | |
| Flex-9 | 90% bisphenol A | 10% bisphenol | — | — | — | — | 1.0% Irgacure ™ |
| | ethoxylate | A ethoxylate | | | | | 184 |
| | (15EO/phenol) | (4EO/phenol) | | | | | |
| | dimethacrylate | diacrylate | | | | | |
| | (MW ~1700) | | | | | | |
| Flex-10 | 99% bisphenol A | 1% bisphenol A | — | — | — | — | 1.0% Irgacure ™ |
| | ethoxylate | ethoxylate | | | | | 184 |
| | (15EO/phenol) | (4EO/phenol) | | | | | |
| | dimethacrylate | diacrylate | | | | | |
| | (MW ~1700) | | | | | | |
| Flex-11 | 10% bisphenol A | 90% trimethylolpropane | — | — | — | — | 1.0% Irgacure ™ |
| | ethoxylate | triacrylate | | | | | 184 |
| | (15EO/phenol) | | | | | | |
| | dimethacrylate | | | | | | |
| | (MW ~1700) | | | | | | |
| Flex-12 | 20% bisphenol A | 80% trimethylolpropane | — | — | — | — | 1.0% Irgacure ™ |
| | ethoxylate | triacrylate | | | | | 184 |
| | (15EO/phenol) | | | | | | |
| | dimethacrylate | | | | | | |
| | (MW ~1700) | | | | | | |
| Flex-13 | 30% bisphenol A | 70% trimethylolpropane | — | — | — | — | 1.0% Irgacure ™ |
| | ethoxylate | triacrylate | | | | | 184 |
| | (15EO/phenol) | | | | | | |
| | dimethacrylate | | | | | | |
| | (MW ~1700) | | | | | | |
| Flex-14 | 40% bisphenol A | 60% trimethylolpropane | — | — | — | — | 1.0% Irgacure ™ |
| | ethoxylate | triacrylate | | | | | 184 |
| | (15EO/phenol) | | | | | | |
| | dimethacrylate | | | | | | |
| | (MW ~1700) | | | | | | |
| Flex-15 | 50% bisphenol A | 50% trimethylolpropane | — | — | — | — | 1.0% Irgacure ™ |
| | ethoxylate | triacrylate | | | | | 184 |
| | (15EO/phenol) | | | | | | |
| | dimethacrylate | | | | | | |
| | (MW ~1700) | | | | | | |
| Flex-16 | 60% bisphenol A | 40% trimethylolpropane | — | — | — | — | 1.0% Irgacure ™ |
| | ethoxylate | triacrylate | | | | | 184 |
| | (15EO/phenol) | | | | | | |
| | dimethacrylate | | | | | | |
| | (MW ~1700) | | | | | | |
| Flex-17 | 70% bisphenol A | 30% trimethylolpropane | — | — | — | — | 1.0% Irgacure ™ |
| | ethoxylate | triacrylate | | | | | 184 |
| | (15EO/phenol) | | | | | | |
| | dimethacrylate | | | | | | |
| | (MW ~1700) | | | | | | |
| Flex-18 | 80% bisphenol A | 20% trimethylolpropane | — | — | — | — | 1.0% Irgacure ™ |
| | ethoxylate | triacrylate | | | | | 184 |
| | (15EO/phenol) | | | | | | |
| | dimethacrylate | | | | | | |
| | (MW ~1700) | | | | | | |
| Flex-19 | 90% bisphenol A | 10% trimethylolpropane | — | — | — | — | 1.0% Irgacure ™ |
| | ethoxylate | triacrylate | | | | | 184 |
| | (15EO/phenol) | | | | | | |
| | dimethacrylate | | | | | | |
| | (MW ~1700) | | | | | | |
| Flex-20 | 99% bisphenol A | 1% trimethylol- | — | — | — | — | 1.0% Irgacure ™ |
| | ethoxylate | propane | | | | | 184 |
| | (15EO/phenol) | triacrylate | | | | | |
| | dimethacrylate | | | | | | |
| | (MW ~1700) | | | | | | |
| Flex-21 | 60% bisphenol A | 5% polypropylene | 15% | 10% penta- | 10% bisphenol | 0.25% | 1.5% Irgacure ™ |
| | ethoxylate | glycol | di(trimethylol- | erythritol | A propoxylate | 4-methoxy- | 907 |
| | (15EO/phenol) | dimethacrylate | propane) | triacrylate | (4EO/phenol) | phenol | |
| | dimethacrylate | (MW = 560) | tetraacrylate | | diacrylate | | |
| | (MW ~1700) | | | | | | |
| Flex-22 | 30% bisphenol A | 2.5% polypropylene | 42.5% | 20% penta- | 5% bisphenol A | 0.25% | 0.75% Irgacure ™ |
| | ethoxylate | glycol | di(trimethylol- | erythritol | propoxylate | 4-methoxy- | 907 |
| | (15EO/phenol) | dimethacrylate | propane) | triacrylate | (4EO/phenol) | phenol | |
| | dimethacrylate | (MW = 560) | tetraacrylate | | diacrylate | | |
| | (MW ~1700) | | | | | | |
| Flex-23 | 30% bisphenol A | 2.5% polypropylene | 32.5% | 30% penta- | 5% bisphenol A | 0.25% | 0.75% Irgacure ™ |
| | ethoxylate | glycol | di(trimethylol- | erythritol | propoxylate | 4-methoxy- | 907 |
| | (15EO/phenol) | dimethacrylate | propane) | triacrylate | (4EO/phenol) | phenol | |
| | dimethacrylate | (MW = 560) | tetraacrylate | | diacrylate | | |
| | (MW ~1700) | | | | | | |
| Flex-24 | 74.25% bisphenol | 4.95% polypropylene | 10.89% | 5.94% | 3.97% polypropylene | 0.25% | 0.25% Irgacure ™ |
| | A ethoxylate | glycol | di(trimethylol- | pentaerythritol | glycol | | 369 |
| | (15EO/phenol) | dimethacrylate | propane) | triacrylate | diacrylate | | |
| | dimethacrylate | (MW = 560) | tetraacrylate | | | | |
| | (MW ~1700) | | | | | | |
| Flex-25 | 74.25% bisphenol | 4.95% polypropylene | 10.89% | 5.94% | 3.97% polypropylene | 0.25% | 0.50% Irgacure ™ |
| | A ethoxylate | glycol | di(trimethylol- | pentaerythritol | glycol | 4-methoxy- | 369 |
| | (15EO/phenol) | dimethacrylate | propane) | triacrylate | diacrylate | phenol | |
| | dimethacrylate | (MW = 560) | tetraacrylate | | (MW = 900) | | |
| | (MW ~1700) | | | | | | |
| Flex-26 | 74.25% bisphenol | 4.95% polypropylene | 10.89% | 5.94% | 3.97% polypropylene | 0.25% | 1.00% Irgacure ™ |
| | A ethoxylate | glycol | di(trimethylol- | pentaerythritol | glycol | 4-methoxy- | 369 |
| | (15EO/phenol) | dimethacrylate | propane) | triacrylate | diacrylate | phenol | |
| | dimethacrylate | (MW = 560) | tetraacrylate | | (MW = 900) | | |
| | (MW ~1700) | | | | | | |

*Components A-E together comprise 100% by weight; in addition, additives (F) and photoinitiators (PI) are added, based on 100% by weight of the composition made of components A-E.

TABLE 2
Mechanical characteristics (established in accordance with
DIN 53504 tensile testing protocol) - Examples of claimed
compositions

| | | Modulus of | | | |
|---|---|---|---|---|---|
| | Manufacturer/ | elasticity | | | ε |
| | designation | (Young's | σ 0.5% | σ break | (Fmax) |
| | of SLA resin | modulus) (MPa) | (MPa) | (MPa) | (%) |
| Flex-1 | ** | 32.31 | 0.15 | 0.96 | 4.16 |
| Flex-2 | ** | 27.59 | 0.18 | 1.77 | 6.99 |
| Flex-3 | ** | 25.4 | 0.17 | 1.51 | 6.3 |
| Flex-4 | ** | 24.04 | 0.17 | 2.1 | 9.14 |
| Flex-5 | ** | 21.47 | 0.16 | 1.98 | 9.39 |
| Flex-6 | ** | 20.32 | 0.16 | 1.68 | 8.68 |
| Flex-7 | ** | 20.82 | 0.16 | 1.22 | 6.31 |
| Flex-8 | ** | 17.12 | 0.14 | 1.9 | 11.47 |
| Flex-9 | ** | 15.65 | 0.14 | 1.6 | 10.6 |
| Flex-10 | ** | 14.86 | 0.14 | 1.07 | 7.44 |
| Flex-15 | ** | 558.55 | 2.94 | 10.88 | 2.32 |
| Flex-16 | ** | 312.62 | 1.66 | 10.92 | 4.4 |
| Flex-17 | ** | 151.1 | 0.8 | 8.91 | 6.88 |
| Flex-18 | ** | 72.6 | 0.41 | 6.54 | 9.84 |
| Flex-19 | ** | 34.29 | 0.22 | 3.05 | 9.38 |
| Flex-20 | ** | 16.12 | 0.13 | 1.51 | 10.13 |
| Flex-21 | ** | 97.78 | 0.52 | 2.41 | 2.43 |
| Flex-22 | ** | 604.65 | 3.13 | 13.73 | 2.98 |
| Flex-23 | ** | 626.17 | 3.2 | 14.72 | 3.24 |
| Flex-24 | ** | 50.4 | 0.28 | 2.73 | 5.71 |
| Flex-25 | ** | 54.27 | 0.31 | 5.37 | 10.5 |
| Flex-26 | ** | 56.11 | 0.32 | 5.42 | 10.73 |

** Composition admixed by research center caesar of Bonn (see also Table 1)

TABLE 3
Mechanical characteristics (established in accordance with
DIN 53504 tensile testing protocol) - Comparative Examples
(commercial materials and our own compositions)

| | | Modulus of | | | |
|---|---|---|---|---|---|
| | | elasticity | | | |
| | Manufacturer/ | (Young's | | | ε |
| | designation of | modulus) | σ 0.5% | σ break | (Fmax) |
| | SLA resin | (MPa) | (MPa) | (MPa) | (%) |
| Comp. | **Flex-11 | 1841 | 9.61 | 14.4 | 0.75 |
| Example C-1 | | | | | |
| Comp. | **Flex-12 | 1713 | 9.14 | 15.49 | 0.9 |
| Example C-2 | | | | | |
| Comp. | **Flex-13 | 1287 | 6.72 | 18.2 | 1.65 |
| Example C-3 | | | | | |
| Comp. | **Flex-14 | 877 | 4.48 | 12.65 | 1.54 |
| Example C-4 | | | | | |
| Comp. | Huntsman | 2854 | n.a. | 66 | 5.4 |
| Example 1* | SL 5510 | | | | |
| Comp. | Huntsman | 1400-1900 | n.a. | 35-40 | 12-21 |
| Example 2* | SL 7545 | | | | |
| Comp. | Huntsman | 2300 | n.a. | 53 | 11 |
| Example 3* | Y-C-9300R | | | | |
| Comp. | DSM Somos | 1710 | n.a. | 26 | 4.2 |
| Example 4* | 10120 | | | | |
| Comp. | 3D Systems | 3100-3307 | n.a. | 64-65 | 4.6-5.0 |
| Example 5* | (RPC) | | | | |
| | Accura SI 10 | | | | |
| Comp. | 3D Systems | 3514-3996 | n.a. | 22-38 | 0.5-1.0 |
| Example 6* | (RPC) | | | | |
| | Amethyst | | | | |

*taken from the Technical Data Sheets of the respective manufacturer (see column 2 for the manufacturer's name and the trade name of the SLA resin);
**Composition admixed by research center caesar of Bonn (see also Table 1)

TABLE 4
Process technology parameters (depth of penetration Dp) and critical
energy EC

| | | Dp (μm) | EC (mJ/cm²) |
|---|---|---|---|
| Flex-21 | M | 10.6 | 3.2 |
| Flex-22 | M | 19.8 | 2.8 |
| Flex-23 | M | 21.1 | 2.9 |
| Flex-21 | V | 223.5 | 13.6 |
| Flex-22 | V | 515.6 | 20.6 |
| Flex-23 | V | 505.5 | 19.5 |
| Flex-24 | V | 4.2 | 4.8 |
| Flex-25 | V | 3.1 | 3.2 |
| Flex-26 | V | 38.1 | 1.4 |
| Comparative | H | 121.9 | 8.9 |
| Example 1* | | | |
| Comparative | H | 182.9 | 11.0 |
| Example 2* | | | |
| Comparative | H | 238.8 | 8.4 |
| Example 3* | | | |
| Comparative | H | 160 | 9.7 |
| Example 4* | | | |
| Comparative | H | 127 | 13.2 |
| Example 5* | | | |
| Comparative | H | 94 | 14.4 |
| Example 6* | | | |

Note:
M = MSTL (HeCd laser, wavelength 325 nm);
V = Viper (3D Systems Inc.; solid-state laser, wavelength 355 nm);
H = taken from the Technical Data Sheet of the respective manufacturer
(*see Table 3 for the manufacturer and designation; the data are based on a solid-state laser with a wavelength of 355 nm)

### Examples Flex-27 to Flex-128

### Materials

The chemicals were taken as purchased from Sigma-Aldrich Inc. or were commercial samples and products from Sartomer Company Inc., Cray Valley S.A. or from Rahn AG. Photoinitiators and other additives were samples or commercial products from Ciba Specialty Chemicals, Sigma-Aldrich Inc. or were purchased from Rahn AG.

Handling chemicals and solvents for the stereolithography process were purchased from Carl-Roth GmbH, Sigma-Aldrich GmbH and from Dow Corning Inc. (TPnB).

### Mixing of Formulations

a. All (meth)acrylates were weight into glassware equipment according to their percentage and then the photoinitiator summed up to 1% of weight of this acrylates mixture was added. Then the formulations were mixed in complete darkness at room temperature and normal atmosphere for additional 24 hours. or method
b. For advanced resin formulations the components were weight into a stainless steel tank (3-12 liter volume) and were stirred with a laboratory dissolver from ATP Engineering at 2000-4000 rpm for 30 to 90 minutes. Then the resins are kept for 24 hours in the dark before processing them on SLA (3D Systems Viper Si²) equipment.

### Testing of Mechanical Properties

The samples were then poured into silicon negative-forms to give tensile probes in the needed geometry according to DIN 53504 and DIN EN ISO 527-1. These liquid samples were then irradiated with a quicksilver high-pressure lamp (Lumatec SUV-DC-P) with 30mW/cm² and an energy dose of 1.8 J/cm². After that, the hardened samples were cleaned with a paper and acetone and were then measured in a universal testing machine (Zwick-Roell) according to DIN 53504 and DIN EN ISO 527-1. For the measurement the software testX-pert V9.01 of Zwick-Roell was used.

### Testing of Process Parameters Dₚ and E_{c}

To describe a resin's behavior, the well-known Windowpane technique is widely used to capture the working curve of an unknown material. In this method, the resin surface is exposed with a pattern of laser light using different energy doses. Each exposed area shows an individual thick-ness of the cured resin. A linear regression of the logarithmized relative energy dose in the working curve equation

$${C}_{D} = {D}_{P} ln ( \frac{{E}_{max}}{{E}_{C}} ) \qquad ( 1 )$$

leads to the characteristic resin values E_{c} (polymerization energy dose [mJ/cm²]) and Dₚ (penetration depth [mm]) of a stereolithography resin.
Because of the free-floating geometry that is exposed by the laser a high distortion and thus a high error has to be accepted. An improvement of this standard method was necessary for an exact analysis of the influence of different compounds on the curing behavior even for thin layers.
Our own developed protocol uses a quartz-glass window with an exact optical quality as a reference plane (see FIG. 3). In a first step, the absorbance of the quartz-glass plane has to be determined with a UV dosimeter, placed directly under the quartz-glass plane, to calculate a correction factor in order to get a better result of the actual UV radiation, which hits the glass plate. The quartz-glass window is thereafter fixed in a polymer plate-box with a distance of 2 mm to its ground. Then a small liquid resin sample (ca 35-50 ml) that has to be tested is poured in such a way that no air bubbles remain beneath the window and the bottom of the box. Then the box is placed in the building chamber of a stereolithography apparatus and a predefined pattern is exposed with an increasing energy dose in the individual cells. Remaining resin is allowed to drip off for 20 minutes then. In the next step, the cured structure is gently rinsed with TPnB solvent (Dow Corning). After drying on a clean double-folded double-layer tissue for 6 times, each 30 seconds, the quartz-glass window is cleaned from the backside and then the irradiated side is post-cured for 10 minutes in a UV-oven. With the help of a height measuring instrument with a predefined small contact force of 1 N, the thickness of each cured area within the exposed pattern was measured against the quartz-glass surface. This method allows a significantly higher precision (approx. ±5 μm) in comparison to the standard Window-pane method.

Viscosity Measurements were performed on a Thermo-Haake RS 600 rheometer system.

TABLE 5
Composition of Flex-27 to Flex-128 (compounds A-E result to 100%; Additives A/B/filler and photoinitiator is
then added to the 100% of compound A-E)

| | | | | | | | additional | |
|---|---|---|---|---|---|---|---|---|
| | | | | | | | amount | |
| | | | | | | additional amount | of | |
| | | | | | | of | additive | additional amount |
| | Compound | Compound | Compound | Compound | Compound | additive | B/filler | of photoinitiator |
| Formulation | A (%) | B (%) | C (%) | D (%) | E (%) | A (%) | (%) | (%) |
| Flex- | 74.25% Bisphenol | 4.95% Polypropylen | 10.89% | 5.94% | 3.97% Polypropylenglykol- | 0.25% 4- | x | IRG 184 0.5% |
| 27 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 184 1.0% |
| 28 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 369 0.5% |
| 29 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 369 1.0% |
| 30 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 369 0.25% |
| 31 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 500 0.5% |
| 32 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 500 1.0% |
| 33 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 651 0.5% |
| 34 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 651 1.0% |
| 35 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 907 0.5% |
| 36 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 907 1.0% |
| 37 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 1000 0.5% |
| 38 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 1000 1.0% |
| 39 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 1800 0.5% |
| 40 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 1800 1.0% |
| 41 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 2959 0.5% |
| 42 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | IRG 2959 1.0% |
| 43 | A ethoxylat- | glykol-diMA | Di(TMP)- | Pentaerytrol- | diA | Methoxy- | | |
| | (15EO/phenol)- | (MW = 560) | tetraA | triA | (MW = 900) | Phenol | | |
| | di(meth)A | | | | | | | |
| Flex- | 74.25% Bisphenol | 4.95% Polypropylen | 10.89% | 5.94% | 3.97% Polypropylenglykol- | 0.25% 4- | x | 2-(4-Benzoyl-3- |
| 44 | A ethoxylat- | glykol-diMA | Di(TMP)- | Pentaerytrol- | diA | Methoxy- | | hydroxy- |
| | (15EO/phenol)- | (MW = 560) | tetraA | triA | (MW = 900) | Phenol | | phenoxy)ethylacrylate |
| | di(meth)A | | | | | | | 0.5% |
| Flex- | 74.25% Bisphenol | 4.95% Polypropylen | 10.89% | 5.94% | 3.97% Polypropylenglykol- | 0.25% 4- | x | 2-(4-Benzoyl-3- |
| 45 | A ethoxylat- | glykol-diMA | Di(TMP)- | Pentaerytrol- | diA | Methoxy- | | hydroxy- |
| | (15EO/phenol)- | (MW = 560) | tetraA | triA | (MW = 900) | Phenol | | phenoxy)ethylacrylate |
| | di(meth)A | | | | | | | 1.0% |
| Flex- | 50% Bisphenol A | 30% Bisphenol A | 7.50% | 10% Trimethylolpropanol- | 2.50% Polypropylenglykol- | 0.20% 4- | x | IRG 369 0.20% |
| 46 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 369 0.30% |
| 47 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 369 0.50% |
| 48 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 369 0.75% |
| 49 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 369 1.00% |
| 50 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 369 1.25% |
| 51 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 369 1.50% |
| 52 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 907 0.75% |
| 53 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 907 1.00% |
| 54 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 907 1.25% |
| 55 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 907 1.50% |
| 56 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 907 1.75% |
| 57 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 907 2.00% |
| 58 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.10% | IRG 369 0.75% |
| 59 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.20% | IRG 369 0.75% |
| 60 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.30% | IRG 369 0.75% |
| 61 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.40% | IRG 369 0.75% |
| 62 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.50% | IRG 369 0.75% |
| 63 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.10% | IRG 369 0.75% |
| 64 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 622 LD | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.20% | IRG 369 0.75% |
| 65 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 622 LD | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.30% | IRG 369 0.75% |
| 66 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 622 LD | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.50% | IRG 369 0.75% |
| 67 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 622 LD | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.75% | IRG 369 0.75% |
| 68 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 622 LD | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.05% | IRG 907 1.00% |
| 69 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.10% | IRG 907 1.00% |
| 70 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.20% | IRG 907 1.00% |
| 71 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.30% | IRG 907 1.00% |
| 72 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.40% | IRG 907 1.00% |
| 73 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.50% | IRG 907 1.00% |
| 74 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.10% | IRG 907 1.00% |
| 75 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 622 LD | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.20% | IRG 907 1.00% |
| 76 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 622 LD | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.30% | IRG 907 1.00% |
| 77 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 622 LD | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.50% | IRG 907 1.00% |
| 78 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 622 LD | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.75% | IRG 907 1.00% |
| 79 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 622 LD | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 0.05% Tin | IRG 907 1.00% |
| 80 | ethoxylat- | ethoxyylat- | Di(TMP)- | triA | diA | Methoxy- | 622LD & | |
| | (15EO/phenol)- | (4EO/phenol)-diA | tetraA | | (MW = 900) | Phenol | 0.05% Tin | |
| | di(meth)A | | | | | | 328 | |
| Flex- | 50% Bisphenol A | 30% Bisphenol A | 7.50% | 10% Trimethylolpropane- | 2.50% Polypropylenglykol- | 0.20% 4- | 0.20% | IRG 907 1.00% |
| 81 | ethoxylat- | ethoxyylat- | Di(TMP)- | trimethacrylate | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | x | IRG 907 1.00% |
| 82 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 60% Bisphenol A | 20% Bisphenol A | 12.50% | 6% Trimethylolpropanol- | 1.50% Polypropylenglykol- | 0.20% 4- | x | IRG 907 1.00% |
| 83 | ethoxylat- | ethoxyylat- | Di(TMP)- | triA | diA | Methoxy- | | |
| | (15EO/phenol)- | (4EO/phenol)-diA | tetraA | | (MW = 900) | Phenol | | |
| | di(meth)A | | | | | | | |
| Flex- | 60% Bisphenol A | 20% Bisphenol A | 12.50% | 6% Trimethylolpropanol- | 1.50% Polypropylenglykol- | 0.20% 4- | 0.05% | IRG 907 1.00% |
| 84 | ethoxylat- | ethoxyylat- | Di(TMP)- | triA | diA | Methoxy- | Tinuvin | |
| | (15EO/phenol)- | (4EO/phenol)-diA | tetraA | | (MW = 900) | Phenol | 328 | |
| | di(meth)A | | | | | | | |
| Flex- | 30% Bisphenol A | 30% RAHN | 30% | 10% Genomer | x | 0.20% 4- | 0.05% | Rahn Genocure |
| 85 | (15EO/phenol) | Polyether 01-514 | Genomer | 3497 | | Methoxy- | Tinuvin | PMP 1.00% |
| | diMA (MW = 1700) | | 1343/Miramer | | | Phenol | 328 | |
| | | | M320 (EO | | | | | |
| | | | TMP-triA | | | | | |
| | | | MW = 428) | | | | | |
| Flex- | 30% Bisphenol A | 40% RAHN | 20% | 10% Genomer | x | 0.20% 4- | 0.05% | Rahn Genocure |
| 86 | (15EO/phenol) | Polyether 01-514 | Genomer | 3497 | | Methoxy- | Tinuvin | PMP 1.00% |
| | diMA (MW = 1700) | | 1343/Miramer | | | Phenol | 328 | |
| | | | M320 (EO | | | | | |
| | | | TMP-triA | | | | | |
| | | | MW = 428) | | | | | |
| Flex- | 40% Bisphenol A | 30% RAHN | 20% | 10% Genomer | x | 0.20% 4- | 0.05% | Rahn Genocure |
| 87 | (15EO/phenol) | Polyether 01-514 | Genomer | 3497 | | Methoxy- | Tinuvin | PMP 1.00% |
| | diMA (MW = 1700) | | 1343/Miramer | | | Phenol | 328 | |
| | | | M320 (EO | | | | | |
| | | | TMP-triA | | | | | |
| | | | MW = 428) | | | | | |
| Flex- | 40% Bisphenol A | 40% RAHN | 10% | 10% Genomer | x | 0.20% 4- | 0.05% | Rahn Genocure |
| 88 | (15EO/phenol) | Polyether 01-514 | Genomer | 3497 | | Methoxy- | Tinuvin | PMP 1.00% |
| | diMA (MW = 1700) | | 1343/Miramer | | | Phenol | 328 | |
| | | | M320 (EO | | | | | |
| | | | TMP-triA | | | | | |
| | | | MW = 428) | | | | | |
| Flex- | 50% Bisphenol A | 30% RAHN | 15% | 5% Genomer | x | 0.20% 4- | 0.05% | Rahn Genocure |
| 89 | (15EO/phenol) | Polyether 01-514 | Genomer | 3497 | | Methoxy- | Tinuvin | PMP 1.00% |
| | diMA (MW = 1700) | | 1343/Miramer | | | Phenol | 328 | |
| | | | M320 (EO | | | | | |
| | | | TMP-triA | | | | | |
| | | | MW = 428) | | | | | |
| Flex- | 50% Bisphenol A | 40% RAHN | 10% | x | x | 0.20% 4- | 0.05% | Rahn Genocure |
| 90 | (15EO/phenol) | Polyether 01-514 | Genomer | | | Methoxy- | Tinuvin | PMP 1.00% |
| | diMA (MW = 1700) | | 1343/Miramer | | | Phenol | 328 | |
| | | | M320 (EO | | | | | |
| | | | TMP-triA | | | | | |
| | | | MW = 428) | | | | | |
| Flex- | 60% Bisphenol A | 20% Bisphenol A | 12.50% | 6% Trimethylolpropanol- | 1.50% Polypropylenglykol- | 0.20% 4- | 0.20% | Rahn Genocure |
| 91 | ethoxylat- | ethoxyylat- | Di(TMP)- | triA | diA | Methoxy- | Tinuvin | PMP 1.00% |
| | (15EO/phenol)- | (4EO/phenol)-diA | tetraA | | (MW = 900) | Phenol | 328 | |
| | di(meth)A | | | | | | | |
| Flex- | 65% RAHN | 20% Genomer | 15% | x | x | 0.20% 4- | 0.05% | Rahn Genocure |
| 92 | Polyether 01-514 | 1343/Miramer M320 | Genomer | | | Methoxy- | Tinuvin | PMP 1.00% |
| | | (EO TMP-triA | 3497 | | | Phenol | 328 | |
| | | MW = 428) | | | | | | |
| Flex- | 70% RAHN | 15% Genomer | 15% | x | x | 0.20% 4- | 0.05% | Rahn Genocure |
| 93 | Polyether 01-514 | 1343/Miramer M320 | Genomer | | | Methoxy- | Tinuvin | PMP 1.00% |
| | | (EO TMP-triA | 3497 | | | Phenol | 328 | |
| | | MW = 428) | | | | | | |
| Flex- | 75% RAHN | 10% Genomer | 15% | x | x | 0.20% 4- | 0.05% | Rahn Genocure |
| 94 | Polyether 01-514 | 1343/Miramer M320 | Genomer | | | Methoxy- | Tinuvin | PMP 1.00% |
| | | (EO TMP-triA | 3497 | | | Phenol | 328 | |
| | | MW = 428) | | | | | | |
| Flex- | 75% RAHN | 10% Genomer | 15% | x | x | 0.20% 4- | 0.05% | Rahn Genocure |
| 95 | Polyether 01-514 | 1343/Miramer M320 | Genomer | | | Methoxy- | Tinuvin | PMP 1.00% |
| | | (EO TMP-triA | 3497 | | | Phenol | 328 | |
| | | MW = 428) | | | | | | |
| Flex- | 37.5% RAHN | 5% Genomer | 7.5% | 50% Miramer | x | 0.20% 4- | 0.05% | Rahn Genocure |
| 96 | Polyether 01-514 | 1343/Miramer M320 | Genomer | 2301 (BPA30EO | | Methoxy- | Tinuvin | PMP 1.00% |
| | | (EO TMP-triA | 3497 | diMA) | | Phenol | 328 | |
| | | MW = 428) | | | | | | |
| Flex- | 33.75% RAHN | 4.5% Genomer | 6.75% | 55% Miramer | x | 0.20% 4- | 0.05% | Rahn Genocure |
| 97 | Polyether 01-514 | 1343/Miramer M320 | Genomer | 2301 (BPA | | Methoxy- | Tinuvin | PMP 1.00% |
| | | (EO TMP-triA | 3497 | 30EO/phenol | | Phenol | 328 | |
| | | MW = 428) | | diMA) | | | | |
| Flex- | 30% RAHN | 4% Genomer | 6% Genomer | 60% Miramer | x | 0.20% 4- | 0.05% | Rahn Genocure |
| 98 | Polyether 01-514 | 1343/Miramer M320 | 3497 | 2301 (BPA | | Methoxy- | Tinuvin | PMP 1.00% |
| | | (EO TMP-triA | | 30EO/phenol | | Phenol | 328 | |
| | | MW = 428) | | diMA) | | | | |
| Flex- | 26.25% RAHN | 3.5% Genomer | 5.25% | 65% Miramer | x | 0.20% 4- | 0.05% | Rahn Genocure |
| 99 | Polyether 01-514 | 1343/Miramer M320 | Genomer | 2301 (BPA | | Methoxy- | Tinuvin | PMP 1.00% |
| | | (EO TMP-triA | 3497 | 30EO/phenol | | Phenol | 328 | |
| | | MW = 428) | | diMA) | | | | |
| Flex- | 22.5% RAHN | 3% Genomer | 4.5% | 70% Miramer | x | 0.20% 4- | 0.05% | Rahn Genocure |
| 100 | Polyether 01-514 | 1343/Miramer M320 | Genomer | 2301 (BPA | | Methoxy- | Tinuvin | PMP 1.00% |
| | | (EO TMP-triA | 3497 | 30EO/phenol | | Phenol | 328 | |
| | | MW = 428) | | diMA) | | | | |
| Flex- | 18.75% RAHN | 2.5% Genomer | 3.75% | 75% Miramer | x | 0.20% 4- | 0.05% | Rahn Genocure |
| 101 | Polyether 01-514 | 1343/Miramer M320 | Genomer | 2301 (BPA | | Methoxy- | Tinuvin | PMP 1.00% |
| | | (EO TMP-triA | 3497 | 30EO/phenol | | Phenol | 328 | |
| | | MW = 428) | | diMA) | | | | |
| Flex- | 15% RAHN | 2% Genomer | 3% Genomer | 80% Miramer | x | 0.20% 4- | 0.05% | Rahn Genocure |
| 102 | Polyether 01-524 | 1343/Miramer M320 | 3497 | 2301 (BPA | | Methoxy- | Tinuvin | PMP 1.00% |
| | | (EO TMP-triA | | 30EO/phenol | | Phenol | 328 | |
| | | MW = 428) | | diMA) | | | | |
| Flex- | 45% Miramer | 35% RAHN | 10% | 10% Genomer | x | 0.20% 4- | 0.05% | 1.00% Rahn |
| 103 | 2301 (BPA | Polyether 01-514 | Genomer | 1343/Miramer | | Methoxy- | Tinuvin | Genocure PMP |
| | 30EO/phenol diMA) | | 3497 | M320 (EO TMP- | | Phenol | 328 | |
| | | | | triA MW = 428) | | | | |
| Flex- | 50% Miramer | 30% RAHN | 10% | 10% Genomer | x | 0.20% 4- | 0.05% | 1.00% Rahn |
| 104 | 2301 (BPA | Polyether 01-514 | Genomer | 1343/Miramer | | Methoxy- | Tinuvin | Genocure PMP |
| | 30EO/phenol diMA) | | 3497 | M320 (EO TMP- | | Phenol | 328 | |
| | | | | triA MW = 428) | | | | |
| Flex- | 55% Miramer | 25% RAHN | 10% | 10% Genomer | x | 0.20% 4- | 0.05% | 1.00% Rahn |
| 105 | 2301 (BPA | Polyether 01-514 | Genomer | 1343/Miramer | | Methoxy- | Tinuvin | Genocure PMP |
| | 30EO/phenol diMA) | | 3497 | M320 (EO TMP- | | Phenol | 328 | |
| | | | | triA MW = 428) | | | | |
| Flex- | 50% Miramer | 20% RAHN | 5% Genomer | 25% Genomer | x | 0.20% 4- | 0.05% | 1.00% Rahn |
| 106 | 2301 (BPA | Polyether 01-514 | 3497 | 1343/Miramer | | Methoxy- | Tinuvin | Genocure PMP |
| | 30EO/phenol diMA) | | | M320 (EO TMP- | | Phenol | 328 | |
| | | | | triA MW = 428) | | | | |
| Flex- | 55% Miramer | 20% RAHN | 5% Genomer | 20% Genomer | x | 0.20% 4- | 0.05% | 1.00% Rahn |
| 107 | 2301 (BPA | Polyether 01-514 | 3497 | 1343/Miramer | | Methoxy- | Tinuvin | Genocure PMP |
| | 30EO/phenol diMA) | | | M320 (EO TMP- | | Phenol | 328 | |
| | | | | triA MW = 428) | | | | |
| Flex- | 60% Miramer | 20% RAHN | 5% Genomer | 15% Genomer | x | 0.20% 4- | 0.05% | 1.00% Rahn |
| 108 | 2301 (BPA | Polyether 01-514 | 3497 | 1343/Miramer | | Methoxy- | Tinuvin | Genocure PMP |
| | 30EO/phenol diMA) | | | M320 (EO TMP- | | Phenol | 328 | |
| | | | | triA MW = 428) | | | | |
| Flex- | 65% Miramer | 20% RAHN | 5% Genomer | 10% Genomer | x | 0.20% 4- | 0.05% | 1.00% Rahn |
| 109 | 2301 (BPA | Polyether 01-514 | 3497 | 1343/Miramer | | Methoxy- | Tinuvin | Genocure PMP |
| | 30EO/phenol diMA) | | | M320 (EO TMP- | | Phenol | 328 | |
| | | | | triA MW = 428) | | | | |
| Flex- | 70% Miramer | 15% RAHN | 5% Genomer | 10% Genomer | x | 0.20% 4- | 0.05% | 1.00% Rahn |
| 110 | 2301 (BPA | Polyether 01-514 | 3497 | 1343/Miramer | | Methoxy- | Tinuvin | Genocure PMP |
| | 30EO/phenol diMA) | | | M320 (EO TMP- | | Phenol | 328 | |
| | | | | triA MW = 428) | | | | |
| Flex- | 75% Miramer | 10% RAHN | 5% Genomer | 10% Genomer | x | 0.20% 4- | 0.05% | 1.00% Rahn |
| 111 | 2301 (BPA | Polyether 01-514 | 3497 | 1343/Miramer | | Methoxy- | Tinuvin | Genocure PMP |
| | 30EO/phenol diMA) | | | M320 (EO TMP- | | Phenol | 328 | |
| | | | | triA MW = 428) | | | | |
| Flex- | 67.5% RAHN | 19% Genomer | 13.5% | x | x | 0.20% 4- | 0.20% | 1.00% Rahn |
| 112 | Polyether 01-514 | 1343/Miramer M320 | Genomer | | | Methoxy- | Tinuvin | Genocure PMP |
| | | (EO TMP-triA | 3497 | | | Phenol | 328 | |
| | | MW = 428) | | | | | | |
| Flex- | 50% Miramer | 20% RAHN | 10% | 20% Genomer | x | 0.20% 4- | 0.05% | 1.00% Rahn |
| 113 | 2301 (BPA | Polyether 01-514 | Genomer | 1343/Miramer | | Methoxy- | Tinuvin | Genocure PMP |
| | 30EO/phenol diMA) | | 3497 | M320 (EO TMP- | | Phenol | 328 | |
| | | | | triA MW = 428) | | | | |
| Flex- | 48.75% Miramer | 19.5% RAHN | 9.75% | 19.5% | 2.5% Genomer | 0.20% 4- | 0.05% | 1.00% Rahn |
| 114 | 2301 (BPA | Polyether 01-514 | Genomer | Genomer | 4256 (UrethanAcrylat) | Methoxy- | Tinuvin | Genocure PMP |
| | 30EO/phenol diMA) | | 3497 | 1343/Miramer | | Phenol | 328 | |
| | | | | M320 (EO TMP- | | | | |
| | | | | triA MW = 428) | | | | |
| Flex- | 47.5% Miramer | 19% RAHN | 9.5% | 19% Genomer | 5% Genomer | 0.20% 4- | 0.05% | 1.00% Rahn |
| 115 | 2301 (BPA | Polyether 01-514 | Genomer | 1343/Miramer | 4256 (UrethanAcrylat) | Methoxy- | Tinuvin | Genocure PMP |
| | 30EO/phenol diMA) | | 3497 | M320 (EO TMP- | | Phenol | 328 | |
| | | | | triA MW = 428) | | | | |
| Flex- | 46.25% Miramer | 18.5% RAHN | 9.25% | 18.5% | 7.5% Genomer | 0.20% 4- | 0.05% | 1.00% Rahn |
| 116 | 2301 (BPA | Polyether 01-514 | Genomer | Genomer | 4256 (UrethanAcrylat) | Methoxy- | Tinuvin | Genocure PMP |
| | 30EO/phenol diMA) | | 3497 | 1343/Miramer | | Phenol | 328 | |
| | | | | M320 (EO TMP- | | | | |
| | | | | triA MW = 428) | | | | |
| Flex- | 45% Miramer | 18% RAHN | 9% Genomer | 18% Genomer | 10% Genomer | 0.20% 4- | 0.05% | 1.00% Rahn |
| 117 | 2301 (BPA | Polyether 01-514 | 3497 | 1343/Miramer | 4256 (UrethanAcrylat) | Methoxy- | Tinuvin | Genocure PMP |
| | 30EO/phenol diMA) | | | M320 (EO TMP- | | Phenol | 328 | |
| | | | | triA MW = 428) | | | | |
| Flex- | 66.3% Bisphenol | 33.7% Poly- | na | na | na | 0.20% 4- | 16.27% | IRG 184 1.4% |
| 118 | A proxyylat- | ethylengycol-diA | | | | Methoxy- | PMMA | |
| | (2PO/phenol)-diA | (MW 575) | | | | Phenol | Pulver 20 μm | |
| Flex- | 50% Bisphenol A | 30% Bisphenol A | 7.50% | 10% Trimethylolpropanol- | 2.50% Polypropylenglykol- | 0.20% 4- | 10% | IRG 369 0.75% |
| 120 | ethoxylat- | ethoxyylat- | Di(TMP)- | triA | diA | Methoxy- | Poly(styrene- | |
| | (15EO/phenol)- | (4EO/phenol)-diA | tetraA | | (MW = 900) | Phenol | co- | |
| | di(meth)A | | | | | | divinyl- | |
| | | | | | | | benzene) | |
| Flex- | 50% Bisphenol A | 30% Bisphenol A | 7.50% | 10% Trimethylolpropanol- | 2.50% Polypropylenglykol- | 0.20% 4- | 30% | IRG 369 0.75% |
| 121 | ethoxylat- | ethoxyylat- | Di(TMP)- | triA | diA | Methoxy- | Poly(styrene- | |
| | (15EO/phenol)- | (4EO/phenol)-diA | tetraA | | (MW = 900) | Phenol | co- | |
| | di(meth)A | | | | | | divinyl- | |
| | | | | | | | benzene) | |
| Flex- | 50% Bisphenol A | 30% Bisphenol A | 7.50% | 10% Trimethylolpropanol- | 2.50% Polypropylenglykol- | 0.20% 4- | 10% glas | IRG 369 0.75% |
| 122 | ethoxylat- | ethoxyylat- | Di(TMP)- | triA | diA | Methoxy- | powder | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 30% glas | IRG 369 0.75% |
| 123 | ethoxylat- | ethoxyylat- | Di(TMP)- | triA | diA | Methoxy- | powder | |
| | (15EO/phenol)- | (4EO/phenol)-diA | tetraA | | (MW = 900) | Phenol | | |
| | di(meth)A | | | | | | | |
| Flex- | 50% Bisphenol A | 30% Bisphenol A | 7.50% | 10% Trimethylolpropanol- | 2.50% Polypropylenglykol- | 0.20% 4- | 10% | IRG 369 0.75% |
| 124 | ethoxylat- | ethoxyylat- | Di(TMP)- | triA | diA | Methoxy- | Poly(methylmethacrylat) | |
| | (15EO/phenol)- | (4EO/phenol)-diA | tetraA | | (MW = 900) | Phenol | copolymer | |
| | di(meth)A | | | | | | 20micron | |
| Flex- | 50% Bisphenol A | 30% Bisphenol A | 7.50% | 10% Trimethylolpropanol- | 2.50% Polypropylenglykol- | 0.20% 4- | 30% | IRG 369 0.75% |
| 125 | ethoxylat- | ethoxyylat- | Di(TMP)- | triA | diA | Methoxy- | Poly(methylmethacrylat) | |
| | (15EO/phenol)- | (4EO/phenol)-diA | tetraA | | (MW = 900) | Phenol | copolymer | |
| | di(meth)A | | | | | | 20micron | |
| Flex- | 50% Bisphenol A | 30% Bisphenol A | 7.50% | 10% Trimethylolpropanol- | 2.50% Polypropylenglykol- | 0.20% 4- | 10% | IRG 369 0.75% |
| 126 | ethoxylat- | ethoxyylat- | Di(TMP)- | triA | diA | Methoxy- | Poly(methylmethacrylat) | |
| | (15EO/phenol)- | (4EO/phenol)-diA | tetraA | | (MW = 900) | Phenol | copolymer | |
| | di(meth)A | | | | | | 8micron | |
| Flex- | 50% Bisphenol A | 30% Bisphenol A | 7.50% | 10% Trimethylolpropanol- | 2.50% Polypropylenglykol- | 0.20% 4- | 30% | IRG 369 0.75% |
| 127 | ethoxylat- | ethoxyylat- | Di(TMP)- | triA | diA | Methoxy- | Poly(methyl- | |
| | (15EO/phenol)- | (4EO/phenol)-diA | tetraA | | (MW = 900) | Phenol | methacrylat) | |
| | di(meth)A | | | | | | copolymer | |
| | | | | | | | 8micron | |
| Flex- | 60% Bisphenol A | 20% Bisphenol A | 12.50% | 6% Trimethylolpropanol- | 1.50% Polypropylenglykol- | 0.20% 4- | 10% | 1.00% Rahn |
| 128 | ethoxylat- | ethoxyylat- | Di(TMP)- | triA | diA | Methoxy- | Wacker | Genocure PMP |
| | (15EO/phenol)- | (4EO/phenol)-diA | tetraA | | (MW = 900) | Phenol & | Genioperl | |
| | di(meth)A | | | | | 0.05% | P22 | |
| | | | | | | Tinuvin | | |
| | | | | | | 328 | | |

“na” or “—” or “X” = no compound
A = acrylate;
diA = diacrylate;
triA = triacrylate;
tetraA = tetraacrylate;
pentaA = pentaacrylate;
hexaA = hexaacrylate
MA = methacrylate;
diMA = dimethacrylate;
triMA = trimethacrylate;
tetraMA = tetramethacrylate;
penta-MA = pentamethacrylate;
hexaMA = hexamethacrylate
Compounds A-E = 100%
Additives A/B/filler plus photoinitiator are additional amounts to the 100% amount of compounds A-E Genomer, Miramer, Genucureare trademarks of Rahn AG (Switzerland)

TABLE 6
Flex-27 to Flex-128: Mechanical test results (Youngs'modulus;
tension strength, elongation at break) and dynamic viscosity (mPas)

| | Young's | s (0.5%) | s b | e F max | Viscosity |
|---|---|---|---|---|---|
| Formulation | Modulus (MPa) | (MPa) | (MPa) | (%) | (mPas) |
| Flex-27 | na | na | na | na | na |
| Flex-28 | na | na | na | na | na |
| Flex-29 | 54.27 | 0.31 | 5.37 | 10.5 | na |
| Flex-30 | 56.11 | 0.32 | 5.42 | 10.73 | na |
| Flex-31 | 50.4 | 0.28 | 2.73 | 5.71 | na |
| Flex-32 | na | na | na | na | na |
| Flex-33 | na | na | na | na | na |
| Flex-34 | 54.42 | 0.31 | 4.94 | 9.69 | na |
| Flex-35 | 59.4 | 0.33 | 3.63 | 6.73 | na |
| Flex-36 | 55.36 | 0.31 | 3.98 | 8.19 | na |
| Flex-37 | 52.15 | 0.29 | 3.21 | 6.49 | na |
| Flex-38 | na | na | na | na | na |
| Flex-39 | na | na | na | na | na |
| Flex-40 | 53.8 | 0.31 | 5.34 | 10.53 | na |
| Flex-41 | 58.8 | 0.33 | 4.43 | 8.28 | na |
| Flex-42 | na | na | na | na | na |
| Flex-43 | na | na | na | na | na |
| Flex-44 | na | na | na | na | na |
| Flex-45 | na | na | na | na | na |
| Flex-46 | 60.76 | 0.34 | 4.2 | 7.73 | na |
| Flex-47 | 52.05 | 0.29 | 3.69 | 7.51 | na |
| Flex-48 | 54.32 | 0.3 | 3.75 | 7.71 | na |
| Flex-49 | 55.05 | 0.31 | 4.42 | 8.78 | na |
| Flex-50 | 53.22 | 0.3 | 4.23 | 4.29 | na |
| Flex-51 | 52.29 | 0.31 | 5.37 | 11.3 | na |
| Flex-52 | 51.73 | 0.3 | 4.23 | 9.24 | na |
| Flex-53 | 48.61 | 0.27 | 1.04 | 2.39 | na |
| Flex-54 | 47.51 | 0.26 | 1.06 | 2.43 | na |
| Flex-55 | 47.56 | 0.26 | 1.41 | 3.21 | na |
| Flex-56 | 44.75 | 0.25 | 1.38 | 3.36 | na |
| Flex-57 | 45.23 | 0.26 | 2.37 | 5.5 | na |
| Flex-58 | 43.41 | 0.25 | 1.89 | 4.66 | na |
| Flex-59 | 53.93 | 0.31 | 4.52 | 8.95 | na |
| Flex-60 | 44.89 | 0.27 | 2.99 | 7.14 | na |
| Flex-61 | 46.85 | 0.28 | 2.83 | 6.39 | na |
| Flex-62 | 48.43 | 0.28 | 2.87 | 6.48 | na |
| Flex-63 | 46.99 | 0.28 | 3.36 | 7.99 | na |
| Flex-64 | 55 | 0.32 | 3.74 | 7.39 | na |
| Flex-65 | 55.54 | 0.3 | 1.99 | 4.26 | na |
| Flex-66 | 48.55 | 0.28 | 2.24 | 4.77 | na |
| Flex-67 | 51.41 | 0.29 | 2.51 | 4.94 | na |
| Flex-68 | 49.53 | 0.28 | 2.43 | 5.21 | na |
| Flex-69 | 41.12 | 0.23 | 1.07 | 3.03 | na |
| Flex-70 | na | na | na | na | na |
| Flex-71 | na | na | na | na | na |
| Flex-72 | na | na | na | na | na |
| Flex-73 | na | na | na | na | na |
| Flex-74 | na | na | na | na | na |
| Flex-75 | 54.39 | 0.31 | 4 | 7.68 | na |
| Flex-76 | 49.71 | 0.29 | 1.31 | 2.66 | na |
| Flex-77 | 48.02 | 0.27 | 0.97 | 2.15 | na |
| Flex-78 | 51.39 | 0.3 | 1.2 | 2.3 | na |
| Flex-79 | 43.29 | 0.25 | 1.12 | 2.62 | na |
| Flex-80 | 35.91 | 0.2 | 0.73 | 2.09 | na |
| Flex-81 | | | | | na |
| Flex-82 | 47.51 | 0.26 | 1.06 | 2.43 | 340 |
| Flex-83 | | | | | na |
| Flex-84 | 70.27 | 0.4 | 4.68 | 7.61 | 390 |
| Flex-85 | na | na | na | na | 425 |
| Flex-86 | na | na | na | na | 630 |
| Flex-87 | na | na | na | na | 534 |
| Flex-88 | na | na | na | na | 791 |
| Flex-89 | na | na | na | na | 588 |
| Flex-90 | na | na | na | na | 751 |
| Flex-91 | 39.16 | 0.38 | 3.04 | 7.5 | na |
| Flex-92 | 68.82 | 0.39 | 1.29 | 2.35 | 1030 |
| Flex-93 | 52.99 | 0.3 | 0.91 | 1.91 | 1240 |
| Flex-94 | 51.08 | 0.3 | 1.11 | 2.54 | 1600 |
| Flex-95 | 79.28 | 0.47 | 5.49 | 9.03 | na |
| Flex-96 | ca. 28 | na | na | na | na |
| Flex-97 | ca. 27 | na | na | na | na |
| Flex-98 | ca. 22 | na | na | na | na |
| Flex-99 | ca. 22 | na | na | na | na |
| Flex-100 | ca. 21 | na | na | na | na |
| Flex-101 | ca. 18 | na | na | na | na |
| Flex-102 | 17.76 | 0.13 | 1.08 | 6.48 | na |
| Flex-103 | na | na | na | na | 718 |
| Flex-104 | na | na | na | na | 678 |
| Flex-105 | na | na | na | na | 611 |
| Flex-106 | na | na | na | na | 412 |
| Flex-107 | na | na | na | na | 467 |
| Flex-108 | na | na | na | na | 503 |
| Flex-109 | na | na | na | na | 568 |
| Flex-110 | na | na | na | na | 523 |
| Flex-111 | na | na | na | na | 487 |
| Flex-112 | na | na | na | na | 1165 |
| Flex-113 | 53.63 | 0.33 | 2.8 | 5.57 | 440 |
| Flex-114 | 40.19 | 0.21 | 1.16 | 3.33 | 525 |
| Flex-115 | 38.53 | 0.21 | 0.82 | 2.17 | 608 |
| Flex-116 | 39.32 | 0.2 | 0.73 | 2.23 | 728 |
| Flex-117 | 34 | 0.16 | 0.4 | 1.84 | 809 |
| Flex-118 | 71.5 | 0.4 | 3.71 | 5.77 | na |
| Flex-120 | 113.9 | 0.63 | 4.35 | 4.65 | na |
| Flex-121 | 66.26 | 0.38 | 3.88 | 6.58 | na |
| Flex-122 | 95.57 | 0.55 | 4.21 | 5.92 | na |
| Flex-123 | 67.67 | 0.39 | 3.62 | 5.52 | na |
| Flex-124 | 105.57 | 0.59 | 4.68 | 5.22 | na |
| Flex-125 | 66.82 | 0.38 | 3.67 | 5.77 | na |
| Flex-126 | 101.9 | 0.56 | 5.59 | 5.9 | na |
| Flex-127 | 1713.16 | 8.59 | 31.61 | 3.45 | na |
| Flex-128 | 60.06 | 0.35 | 3.54 | 7.04 | 768 |

na = not available

TABLE 7
Flex-27 to Flex-128: Process parameters D_{P} and E_{C}

| Formulation | Dp (mils) | Dp (mm) | Dp (μm) | EC mj/cm2 |
|---|---|---|---|---|
| Flex-27 | n.a. | n.a. | n.a. | n.a. |
| Flex-28 | 83.6 | 2.12344 | 2123.44 | 38 |
| Flex-29 | 3.1 | 0.07874 | 78.74 | 3.2 |
| Flex-30 | 1.5 | 0.0381 | 38.1 | 1.4 |
| Flex-31 | 4.2 | 0.10668 | 106.68 | 4.8 |
| Flex-32 | 78.1 | 1.98374 | 1983.74 | 85.4 |
| Flex-33 | 29.8 | 0.75692 | 756.92 | 47.7 |
| Flex-34 | 37.5 | 0.9525 | 952.5 | 22.2 |
| Flex-35 | 16.7 | 0.42418 | 424.18 | 10.6 |
| Flex-36 | 23.8 | 0.60452 | 604.52 | 33.3 |
| Flex-37 | 12.4 | 0.31496 | 314.96 | 15.7 |
| Flex-38 | na | na | na | na |
| Flex-39 | 77 | 1.9558 | 1955.8 | 38.6 |
| Flex-40 | 34.9 | 0.88646 | 886.46 | 21.9 |
| Flex-41 | 24 | 0.6096 | 609.6 | 13.1 |
| Flex-42 | na | na | na | na |
| Flex-43 | 74.1 | 1.88214 | 1882.14 | 74.2 |
| Flex-44 | na | na | na | na |
| Flex-45 | na | na | na | na |
| Flex-46 | 6.8 | 0.17272 | 172.72 | 6 |
| Flex-47 | 4.5 | 0.1143 | 114.3 | 4.2 |
| Flex-48 | 2.9 | 0.07366 | 73.66 | 2.8 |
| Flex-49 | 1.9 | 0.04826 | 48.26 | 1.6 |
| Flex-50 | 1.4 | 0.03556 | 35.56 | 1.2 |
| Flex-51 | 1.1 | 0.02794 | 27.94 | 0.7 |
| Flex-52 | 0.9 | 0.02286 | 22.86 | 0.5 |
| Flex-53 | 15.2 | 0.38608 | 386.08 | 20.7 |
| Flex-54 | 12.1 | 0.30734 | 307.34 | 16.2 |
| Flex-55 | 9.9 | 0.25146 | 251.46 | 13.2 |
| Flex-56 | 8.5 | 0.2159 | 215.9 | 11.4 |
| Flex-57 | 7.5 | 0.1905 | 190.5 | 10.5 |
| Flex-58 | 6.9 | 0.17526 | 175.26 | 9.3 |
| Flex-59 | 1.2 | 0.03048 | 30.48 | 1.5 |
| Flex-60 | 1 | 0.0254 | 25.4 | 1.6 |
| Flex-61 | 0.7 | 0.01778 | 17.78 | 2.2 |
| Flex-62 | 0.8 | 0.02032 | 20.32 | 5.5 |
| Flex-63 | 0.7 | 0.01778 | 17.78 | 9.8 |
| Flex-64 | 1.9 | 0.04826 | 48.26 | 1.5 |
| Flex-65 | 2 | 0.0508 | 50.8 | 1.5 |
| Flex-66 | 1.7 | 0.04318 | 43.18 | 0.7 |
| Flex-67 | 2.2 | 0.05588 | 55.88 | 1.6 |
| Flex-68 | 3.2 | 0.08128 | 81.28 | 1.4 |
| Flex-69 | 4.7 | 0.11938 | 119.38 | 16.7 |
| Flex-70 | 3.3 | 0.08382 | 83.82 | 27.2 |
| Flex-71 | 2.1 | 0.05334 | 53.34 | 37.6 |
| Flex-72 | 1.4 | 0.03556 | 35.56 | 45.6 |
| Flex-73 | 1.2 | 0.03048 | 30.48 | 66.1 |
| Flex-74 | 1.6 | 0.04064 | 40.64 | 114.8 |
| Flex-75 | 12.7 | 0.32258 | 322.58 | 13.1 |
| Flex-76 | 12.4 | 0.31496 | 314.96 | 12.5 |
| Flex-77 | 12.3 | 0.31242 | 312.42 | 12.7 |
| Flex-78 | 12 | 0.3048 | 304.8 | 12 |
| Flex-79 | 12.1 | 0.30734 | 307.34 | 12.2 |
| Flex-80 | 4.8 | 0.12192 | 121.92 | 17.7 |
| Flex-81 | 2.1 | 0.05334 | 53.34 | 37.6 |
| Flex-82 | 12.1 | 0.30734 | 307.34 | 16.2 |
| Flex-83 | 12.3 | 0.31242 | 312.42 | 13.4 |
| Flex-84 | 4.9 | 0.12446 | 124.46 | 17.3 |
| Flex-85 | 4.6 | 0.11684 | 116.84 | 9.9 |
| Flex-86 | 4.1 | 0.10414 | 104.14 | 8.7 |
| Flex-87 | 4.8 | 0.12192 | 121.92 | 9.6 |
| Flex-88 | 4.8 | 0.12192 | 121.92 | 8.7 |
| Flex-89 | 4.7 | 0.11938 | 119.38 | 8.8 |
| Flex-90 | 4.6 | 0.11684 | 116.84 | 9.4 |
| Flex-91 | 1.9 | 0.04826 | 48.26 | 22.7 |
| Flex-92 | 4.9 | 0.12446 | 124.46 | 7.5 |
| Flex-93 | 4.9 | 0.12446 | 124.46 | 7.2 |
| Flex-94 | 4.6 | 0.11684 | 116.84 | 7.6 |
| Flex-95 | 4.6 | 0.11684 | 116.84 | 6.6 |
| Flex-96 | 4.9 | 0.12446 | 124.46 | 9.1 |
| Flex-97 | 4.7 | 0.11938 | 119.38 | 9.7 |
| Flex-98 | 4.8 | 0.12192 | 121.92 | 9.3 |
| Flex-99 | 4.8 | 0.12192 | 121.92 | 8.6 |
| Flex-100 | 4.8 | 0.12192 | 121.92 | 9.5 |
| Flex-101 | 5 | 0.127 | 127 | 9.9 |
| Flex-102 | 4.9 | 0.12446 | 124.46 | 10 |
| Flex-103 | 4.5 | 0.1143 | 114.3 | 9.1 |
| Flex-104 | 4.8 | 0.12192 | 121.92 | 9.6 |
| Flex-105 | 4.8 | 0.12192 | 121.92 | 9.4 |
| Flex-106 | 4.9 | 0.12446 | 124.46 | 9.9 |
| Flex-107 | 4.9 | 0.12446 | 124.46 | 10.4 |
| Flex-108 | 4.8 | 0.12192 | 121.92 | 9.8 |
| Flex-109 | 4.9 | 0.12446 | 124.46 | 9.7 |
| Flex-110 | 4.9 | 0.12446 | 124.46 | 10.3 |
| Flex-111 | 5 | 0.127 | 127 | 11.8 |
| Flex-112 | 1.9 | 0.0471 | 47.1 | 1.6 |
| Flex-113 | 4.5 | 0.1143 | 114.3 | 9.1 |
| Flex-114 | 4.4 | 0.1105 | 110.5 | 8.2 |
| Flex-115 | 4.6 | 0.1175 | 117.5 | 9.4 |
| Flex-116 | 4.6 | 0.1174 | 117.4 | 10.5 |
| Flex-117 | 4.6 | 0.1178 | 117.8 | 9.8 |
| Flex-118 | na | na | na | na |
| Flex-120 | na | na | na | na |
| Flex-121 | na | na | na | na |
| Flex-122 | na | na | na | na |
| Flex-123 | na | na | na | na |
| Flex-124 | na | na | na | na |
| Flex-125 | na | na | na | na |
| Flex-126 | na | na | na | na |
| Flex-127 | na | na | na | na |
| Flex-128 | 5.2 | 0.13208 | 132.08 | 21.6 |

na = not available

1. A liquid radiation-curing composition having flexible and elastic material properties in the cured state, consisting of the following components:
a) from 5.0 to 99.0% by weight of a di- or polyfunctional polyether (meth)acrylate compound having a molecular weight of more than 1000 g/mol;
b) from 1.00 to 90.0% by weight of a mono-, di- or polyfunctional radiation-curing (meth)acrylate compound having a molecular weight of less than 1000 g/mol as a reactive component or reactive thinner or cross-linking agent for the formation of polymer networks;
c) from 0.05 to 10.0% by weight of a free-radical forming photoinitiator;
d) from 0.001 to 5.0% by weight of further components;
with the proviso that the sum of components a) to d) amounts to 100% by weight.

2. The composition according to claim 1, characterized in that the composition additionally contains from 0.01 to 80.0% by weight of a filler materials, the sum of components a) to d) plus the filler material totaling 100% by weight.

3. The composition according to claim 1, characterized in that said polyether (meth)acrylate compound is a mixture of several di- or poly functional polyether (meth)acrylate compounds, said (meth)acrylate compound is a mixture of several mono-, di- or polyfunctional (meth)acrylate compounds, and said free-radical forming photoinitiator is a mixture of several free-radical forming photoinitiators.

4. The composition according to claim 1, characterized in that component a) is selected from the group consisting of alkylether di(meth)- acrylates, arylether di(meth)acrylates, bis(arylether) di(meth)acrylates, alkylether tri(meth)acrylates, arylether tri(meth)acrylates, bis(arylether) tri(meth)acrylates, alkylether poly(meth)acrylates, arylether poly(meth)- acrylates, bis(arylether) poly(meth)acrylates, alkyletheralkoxy di(meth)- acrylates, aryletheralkoxy di(meth)acrylates, bis(arylether)alkoxy di- (meth)acrylates, alkyletheralkoxy tri(meth)acrylates, aryletheralkoxy tri- (meth)acrylates, bis(aryletheralkoxy) tri(meth)acrylates, alkyletheralkoxy poly(meth)acrylates, aryletheralkoxy poly(meth)acrylates, bis(arylether) poly(meth)acrylates, polyalkylether di(meth)acrylates, polyarylether di- (meth)acrylates, polyalkylether tri(meth)acrylates, polyarylether tri-(meth)acrylates, polyalkylether poly(meth)acrylates, polyarylether poly- (meth)acrylates, polyalkyletheralkoxy di(meth)acrylates, polyarylether- alkoxy di(meth)acrylates, polyalkyletheralkoxy tri(meth)acrylates, poly- aryletheralkoxy tri(meth)acrylates, polyalkyletheralkoxy poly(meth)acryl- ates, polyaryletheralkoxy poly(meth)acrylates.

5. The composition according to claim 1, characterized in that component a) is selected from the group consisting of polyalkylether di(meth)acrylates, polyethylene glycol di(meth)acrylates, polypropylene glycol di(meth)acrylates, polyisopropylene glycol di(meth)acrylates, poly- isobutylene glycol di(meth)acrylates, bisphenol A alkoxylated (in particular: methoxylated, ethoxylated, propoxylated, butoxylated and higher C5-C10 alkoxylates) di(meth)acrylates, bisphenol F alkoxylate di(meth)acrylates, bisphenol B alkoxylated (in particular: methoxylated, ethoxylated, propoxylated, butoxylated and higher C5-C10 alkoxylates) di(meth)acrylates, ethoxylated bisphenol A di(meth)acrylates, ethoxylated bisphenol F di(meth)acrylates, ethoxylated bisphenol B di(meth)acrylates, propoxylated bisphenol A di(meth)acrylates, propoxylated bisphenol F di(meth)acrylates, propoxylated bisphenol B di(meth)acrylates and other alkoxylated (in particular: methoxylated, ethoxylated, propoxylated, butoxylated and higher C5-C10 alkoxylates) bisphenol derivative di(meth)acrylates.

6. The composition according to claim 1, characterized in that component b) is selected from the group consisting of alkylether di(meth)- acrylates, arylether di(meth)acrylates, bis(arylether) di(meth)acrylates, alkylether tri(meth)acrylates, arylether tri(meth)acrylates, bis(arylether) tri(meth)acrylates, alkylether poly(meth)acrylates, arylether poly(meth)- acrylates, bis(arylether) poly(meth)acrylates, alkyletheralkoxy di(meth)- acrylates, aryletheralkoxy di(meth)acrylates, bis(aryletheralkoxy) di- (meth)acrylates, alkyletheralkoxy tri(meth)acrylates, aryletheralkoxy tri- (meth)acrylates, bis(aryletheralkoxy) tri(meth)acrylates, alkyletheralkoxy poly(meth)acrylates, aryletheralkoxy poly(meth)acrylates, bis(arylether) poly(meth)acrylates, polyalkylether di(meth)acrylates, polyarylether di- (meth)acrylates, polyalkylether tri(meth)acrylates, polyarylether tri-(meth)acrylates, polyalkylether poly(meth)acrylates, polyarylether poly-(meth)acrylates, polyalkyletheralkoxy di(meth)acrylates, polyarylether-alkoxy di(meth)acrylates, polyalkyletheralkoxy tri(meth)acrylates, poly-aryletheralkoxy tri(meth)acrylates, polyalkyletheralkoxy poly(meth)acryl- ates, polyaryletheralkoxy poly(meth)acrylates, n-alkyl (in particular: methyl, ethyl, propyl, butyl and higher C5-C10 alkyls)(meth)acrylates or branched-chain alkyl (meth)acrylates with alkyl carbon chain lengths of from 1 to 18 carbon atoms, hydroxyalkyl (meth)acrylates, phenoxyalkyl (meth)acrylates, isobornyl (meth)acrylate, tetrahydrofurfuryl (meth)acryl-ate, cyclohexyl (meth)acrylate, dicyclopentenyl (meth)acrylate, dicyclo- pentenyloxyalkyl (meth)acrylates, methoxyether (meth)acrylates, eth- oxyether (meth)acrylates, aliphatic urethane(meth)acrylates, aromatic urethane (meth)acrylates, aliphatic polyether urethane (meth)acrylates, aromatic polyether urethane (meth)acrylates, aliphatic polyester urethane (meth)acrylates, aromatic polyester urethane (meth)acrylates, alkenyl glycol di(meth)acrylates, aliphatic di(meth)acrylates, allyl (meth)acrylates, trimethylolpropane tri(meth)acrylate, pentaerythritol tri(meth)acrylate, ethoxylated trimethylolpropane tri(meth)acrylate, ethoxylated pentaerythritol tri(meth)acrylate, propoxylated trimethylolpro-pane tri(meth)acrylate, propoxylated pentaerythritol tri(meth)acrylate, ethoxylated glyceryl tri(meth)acrylate, propoxylated glyceryl tri(meth)acrylate/tris(2-hydroxyalkyl) isocyanurate tri(meth)acrylates, al-lylether (meth)acrylates, trivinylether (meth)acrylates, pentaerythritol tetra(meth)acrylate, ditrimethylolpropane tetra(meth)acrylate, alkoxylated (in particular: methoxylated, ethoxylated, propoxylated, butoxylated and higher C5-C10 alkoxylates) tri(meth)acrylates/alkoxylated (in particular: methoxylated, ethoxylated, propoxylated, butoxylated and higher C5-C10 alkoxylates) tetra(meth)acrylates, alkoxylated (in particular: methoxylated, ethoxylated, propoxylated, butoxylated and higher C5-C10 alkoxylates) penta(meth)acrylates, alkoxylated (in particular: methoxylated, ethoxylated, propoxylated, butoxylated and higher C5-C10 alkoxylates) hexa(meth)acrylates, dipentaerythritol penta(meth)acrylate, dipentaerythritol hexa(meth)acrylate.

7. The composition according to claim 1, characterized in that component b) is selected from the group consisting of polyalkylether di(meth)acrylates, polyethylene glycol di(meth)acrylates, polypropylene glycol di(meth)acrylates, polyisopropylene glycol di(meth)acrylates, poly-isobutylene glycol di(meth)acrylates, bisphenol A alkoxylated (in particular: methoxylated, ethoxylated, propoxylated, butoxylated and higher C5-C10 alkoxylates) di(meth)acrylates, bisphenol F alkoxylated (in particular: methoxylated, ethoxylated, propoxylated, butoxylated and higher C5-C10 alkoxylates) di(meth)acrylates, bisphenol B alkoxylated (in particular: methoxylated, ethoxylated, propoxylated, butoxylated and higher C5-C10 alkoxylates) di(meth)acrylates, ethoxylated bisphenol A di(meth)acrylates, ethoxylated bisphenol F di(meth)acrylates, ethoxylated bisphenol B di(meth)acrylates, propoxylated bisphenol A di(meth)acrylates, propoxylated bisphenol F di(meth)acrylates, propoxylated bisphenol B di(meth)acrylates, alkoxylated (in particular: methoxylated, ethoxylated, propoxylated, butoxylated and higher C5-C10 alkoxyates) bisphenol derivative di(meth)acrylates, n-alkyl (in particular: methyl, ethyl, propyl, butyl and higher C5-C10 alkyls)(meth)acrylates or branched-chain alkyl (meth)acrylates with alkyl carbon chain lengths of from 1 to 12 carbon atoms, hydroxyalkyl (meth)acrylates with alkyl carbon chain lengths of from 1 to 12 carbon atoms, phenoxyalkyl (meth)-acrylates, isobornyl (meth)acrylate, tetrahydrofurfuryl (meth)acrylate, cyclohexyl (meth)acrylate, dicyclopentenyl (meth)acrylate, dicyclopen-tenyloxyalkyl (meth)acrylates, methoxyether (meth)acrylates, ethoxy-ether (meth)acrylates, alkenyl glycol di(meth)acrylates, aliphatic di-(meth)acrylates, allyl (meth)acrylates, trimethylolpropane tri(meth)-acrylate, pentaerythritol tri(meth)acrylate, ethoxylated trimethylolpropane tri(meth)acrylate, ethoxylated pentaerythritol tri(meth)acrylate, propoxy-lated trimethylolpropane tri(meth)acrylate, propoxylated pentaerythritol tri(meth)acrylate, ethoxylated glyceryl tri(meth)acrylate, propoxylated glyceryl tri(meth)acrylate, pentaerythritol tetra(meth)acrylate, ditrimethy-lolpropane tetra(meth)acrylate, alkoxylated (in particular: methoxylated, ethoxylated, propoxylated, butoxylated and higher C5-C 10 alkoxylates) tri(meth)acrylates, alkoxylated (in particular: methoxylated, ethoxylated, propoxylated, butoxylated and higher C5-C10 alkoxylates) tetra(meth)acrylates, alkoxylated (in particular: methoxylated, ethoxylated, propoxylated, butoxylated and higher C5-C10 alkoxylates) penta(meth)acrylates, alkoxylated (in particular: methoxylated, ethoxylated, propoxylated, butoxylated and higher C5-C10 alkoxylates) hexa(meth)acrylates, dipentaerythritol penta(meth)acrylate, dipenta-erythritol hexa(meth)acrylate.

8. The composition according to claim 1, characterized in that component c) is selected from the group consisting of benzoin ether, benzil ketals, α,α-dialkyloxyacetophenone derivatives; hydroxyalkylphenones, oc-aminoalkylphenones, acylphosphine oxides, phenylglyoxalates, benzophe-none derivatives, thioxanthone derivatives, 1,2-diketones, aromatic ketones, (meth)acrylate-esterified benzoin ethers, benzil ketals, (meth)-acrylate-esterified α,α-dialkyloxyacetophenone derivatives; (meth)acryl-ate-esterified hydroxyalkylphenones, (meth)acrylate-esterified α-amino-alkylphenones, (meth)acrylate-esterified acylphosphine oxide, phenylglyoxalates, (meth)acrylate-esterified benzophenone derivatives, (meth)-acrylate-esterified thioxanthone derivatives, (meth)acrylate-esterified 1,2-diketones, (meth)acrylate-esterified aromatic ketones, and amine-based co-photoinitiators.

9. The composition according to claim 1, characterized in that component c) comprises a proportion of from 0.1 to 2.5% by weight and is selected from the group consisting of benzoin ether, benzil ketals, α,α-dialkyloxyacetophenone derivatives; hydroxyalkylphenones, α-aminoalkyl-phenones, acylphosphine oxides, phenylglyoxalates, benzophenone derivatives, thioxanthone derivatives, 1,2-diketones, aromatic ketones, (meth)acrylate-esterified benzoin ethers, benzil ketals, (meth)acrylate-esterified α,α-dialkyloxyacetophenone derivatives; (meth)acrylate-esteri-fied hydroxyalkylphenones, (meth)acrylate-esterified α-aminoalkylphen-ones, (meth)acrylate-esterified acylphosphine oxide, phenylglyoxalates, (meth)acrylate-esterified benzophenone derivatives, (meth)acrylate-esterified thioxanthone derivatives, (meth)acrylate-esterified 1,2-diketones, (meth)acrylate-esterified aromatic ketones, and amine-based co-photoinitiators.

10. The composition according to claim 2, characterized in that said filler material is selected from the group consisting of polymethacrylates, polyacrylates, polyesters, polyamides, polyimines, polyethers, polyure-thanes, polyaryls, polystyrenes, polyvinylpyrrolidones, polylactides, polysaccharides, polysiloxanes, polysilicones, (meth)acrylate-silicone and sili-cone-(meth)acrylate core-shell copolymers in form of beads or powder or other types of structured polymer blends, hydroxyapatite, tricalcium phosphate, calcium sulfates, calcium phosphates, calcium phosphites, calcium carbonates, calcium oxalates, titanium dioxide, silica in the form of glass beads or glass fibers or finely ground glass dust.

11. The composition according to claim 1, characterized in that component d) is selected from the group consisting of antioxidants, polymerization inhibitors, stabilizers, processing aids, photosensitive acids, photosensitive bases, dyes (in particular photochromic dyes, thermochromic dyes and reactive dyes), pigments, emulsifiers, dispersing agents, wetting agents, adhesion promoters, flow-control agents, solvents, viscosity modifiers, defoamers, flame-retardant agents, ultraviolet active stabilizers, lightstabilizers, film-forming agents and anti-ageing components.

12. A product obtainable by irradiating the composition according to claim 1 with actinic radiation.

13. The product according to claim 12 having a modulus of elasticity (Young's modulus) as measured of at most 650 MPa and an elongation at break ε (Fmax) of at least 2.0%.

14. The product according to claim 12, characterized in that said product is a three-dimensional shaped object.

15. A process for the preparation of a three-dimensional shaped object, especially with the use of computer-controlled process techniques for data processing, data preparation and process control, consisting of the following steps:
a) curing or solidifying a two-dimensional layered body at the boundary layer of the liquid radiation-curing composition according to claim 1;
b) producing another uncured two-dimensional layer by a parallel vertical translation by a defined distance from the layer obtained in a);
c) curing or solidifying the two-dimensional layer obtained in b) to form a three-dimensional cohesive body with the cured layer from a);
d) repeating the steps b) and c) several times to produce a three-dimensional shaped object.

16. The process according to claim 15 using lithographic, especially stereo-lithographic, methods.

17. The process according to claim 15, characterized in that said three-dimensional shaped objects are produced layer by layer by mask or point or area exposure to actinic radiation from a range of from 200 to 600 nm.

18. The process according to claim 15 using actinic radiation from a range of from 250 to 450 nm.

19. The process according to claim 15 using lasers.

20. The process according to claim 15 using ultraviolet lasers, such as dye lasers, gas lasers, especially helium-cadmium lasers, and solid-state lasers, especially frequency-multiplied neodymium-solid state lasers.

21. A process for the treatment of three-dimensional shaped objects obtainable according to claim 15.

22. The process according to claim 21, characterized in that said three-dimensional shaped objects are stored in a solvent at temperatures of from 20 to 1000 C for periods of from 5 minutes to 72 hours, said solvent preferably being selected from the group consisting of acetone, methanol, ethanol, propanol, isopropanol and further alcohols, especially primary, secondary or tertiary carbon alkane alcohols having carbon chain lengths of from 4 to 12 carbon atoms, in addition to alkane (poly)ether compounds and alkylglycol alkyl ethers, especially TPM (tripropylene glycol methyl ether), TPnB (tripropylene glycol n-butyl ether) and DPnP (dipro- pylene glycol n-propyl ether).

23. The process according to claim 21, characterized in that said three-dimensional shaped objects are subjected to ultrasonication.

24. The process according to claim 21, characterized in that said three-dimensional shaped objects are after-exposed by exposure to actinic radiation, preferably within a range of from 250 to 400 nm, for a period of from 1 minute to 12 hours, preferably for a period of from5 minutes to 60 minutes.

25. The process according to claim 21, characterized in that said three-dimensional shaped objects are subjected to thermal treatment in a temperature range of from 20 to 2000C.

26. The process according to claim 21, characterized in that said three-dimensional shaped objects are subjected to polymer, metal or ceramic coating, preferably paint coating with polymer lacquers.

27. A three-dimensional shaped object obtainable by a process according to claim 15.

28. The three-dimensional shaped object according to claim 27 having a modulus of elasticity (Young's modulus) as measured of at most 750 MPa and an elongation at break ε (Fmax) of at least 2.0%.

29. Use of a three-dimensional shaped object according to claim 14 for tasks in medicine and medical technology, especially as a model for anatomic hard and soft tissue representations, as a model for the preparation and planning of surgery, as a drilling template or positioning aid in surgical interventions or as an aid for supporting instrument navigation in surgical interventions, as an eye, nose, face and ear epithesis, obturator prosthesis, ear epithesis and hearing aid and as an otoplastic, as a lining, coating or exterior wall of medical instruments and devices, especially instruments and devices individually adapted to the patient, and as a long-term or short-term implant in the body of a mammal, especially a human.
